(19) United States
(12) Patent Application Publication
(10) Pub. No.: US 2014/0314991 A1
(43) Pub. Date: Oct. 23, 2014

(54) METHODS AND ARTICLES FOR LIQUID-IMPREGNATED SURFACES FOR THE INHIBITION OF VAPOR OR GAS NUCLEATION

(71) Applicant: LiquiGlide Inc., Boston, MA (US)

(72) Inventors: Jonathan David Smith, Cambridge, MA (US); Colin Gounden, Cambridge, MA (US); Jose Yague, Somerville, MA (US)

(73) Assignee: LiquiGlide Inc., Boston, MA (US)

(21) Appl. No.: 14/215,241

(22) Filed: Mar. 17, 2014

Related U.S. Application Data
(60) Provisional application No. 61/794,335, filed on Mar. 15, 2013.

(51) Int. Cl. F01D 5/28; A47J 36/02

(52) U.S. Cl. CPC F01D 5/28; A47J 36/025
USPC 428/141; 220/573.1; 416/241 R

(57) ABSTRACT

Embodiments described herein relate generally to devices, systems and methods for producing liquid-impregnated surfaces for the inhibition of vapor or gas nucleation. In some embodiments, an apparatus having a liquid-impregnated surface includes a first surface having a first roll off angle. A plurality of solid features are disposed on the first surface such that interstitial regions are defined between the solid features. An impregnating liquid is disposed in the interstitial regions which are dimensioned and configured to remain impregnated by the impregnating liquid. The impregnating liquid disposed in the interstitial regions at least partially defines a second surface having a second roll off angle less than the first roll off angle. Furthermore, the second surface has substantially less nucleation sites for formation of bubbles in a contact liquid that includes a gas dissolved therein and is disposed on the second surface, as compared to the first surface.

### CROSS-REFERENCE TO RELATED APPLICATIONS

This application claims priority to U.S. Provisional Patent Application No. 61/794,335, entitled “Methods and Articles for Liquid-Impregnated Surfaces for Inhibition of Vapor and Gas Nucleation,” filed Mar. 15, 2013 the disclosure of which is incorporated herein by reference in its entirety.

### BACKGROUND

Embodiments described herein relate generally to devices, systems and methods for producing liquid-impregnated surfaces for the inhibition of vapor or gas nucleation.

Nucleation phenomena typically occur heterogeneously (on a surface) at cracks or surface defects, where there is a significantly lower energy barrier to nucleation. On perfectly smooth surfaces, such as liquid surfaces, the energy barrier to nucleation can be very high, and nucleation may not occur even when the external environment becomes significantly supersaturated.

Carbonated or “fizzy” beverages such as soft drinks and many types of beer have a limited shelf life because they tend to go flat over time, i.e., lose a substantial portion of the dissolved carbon dioxide. Nucleation at the interior surfaces of container releases the carbon dioxide from the liquid phase which can seep out from the cap seal and diffuse through the plastic over time. By altering interior surface of the containers to increase the energy barrier to nucleation and by preventing gas from coming out of solution, the shelf life of these beverages can be extended.

Water and other liquids have a specific boiling point at atmospheric pressure. This boiling point can be altered by changing the external pressures on the liquid and by altering the vapor pressures of the liquids themselves. In certain applications, it is desirable to raise a liquid above its boiling point by increasing the external pressure on the liquid, and without altering the vapor pressure of the liquid itself.

Cavitation is the formation and then immediate implosion of cavities in a liquid usually as a result of rapid changes in pressure. Cavitation can occur on the surface of impellers or propellers. Cavitation typically begins at a nucleation site where bubbles of saturated vapor form in a low pressure area of the liquid. Cavitation can significantly reduce the efficiency of impellers or propellers of displacing the liquid, can cause noise, and wear and corrosion on the surface. During cavitation, an impeller or propeller loses thrust when the vaporous cavitation bubble forms.

Thus, there is a need for surfaces with an energy barrier to nucleation. In particular, there is a need for surfaces with reduced nucleation sites which inhibit the release of gases dissolved in liquids. There is also a need for surfaces with reduced nucleation sites which inhibit the start of the boiling process. There is also a need for surfaces with reduced nucleation sites that inhibit the formation of cavitation bubbles.

### SUMMARY

Embodiments described herein relate generally to devices, systems and methods for producing liquid-impregnated surfaces for the inhibition of vapor or gas nucleation. In some embodiments, an apparatus having a liquid-impregnated surface includes a first surface having a first roll off angle. A plurality of solid features are disposed on the first surface such that interstitial regions are defined between the solid features. An impregnating liquid is disposed in the interstitial regions which are dimensioned and configured to remain impregnated by the impregnating liquid through capillarity. The impregnating liquid disposed in the interstitial regions at least partially defines a second surface having a second roll off angle less than the first roll off angle. Furthermore, the second surface has substantially less nucleation sites for formation of bubbles in a contact liquid that includes a gas dissolved therein and is disposed on the second surface, as compared to the first surface.

### BRIEF DESCRIPTION OF THE DRAWINGS

FIG. 1 is a schematic illustration of a liquid-impregnated surface according to an embodiment

FIG. 2A shows a schematic illustration of a droplet of a liquid on a surface showing a critical contact angle. FIG. 2B shows the advancing and receding contact angles of the liquid droplet when the surface is inclined.

FIG. 3 is a scanning electron micrograph of a surface with semi solid features according, to an embodiment.

FIG. 3 is a scanning electron micrograph of a surface with hierarchical semi solid features, according to an embodiment.

FIG. 5 is a scanning electron micrograph of the surface of FIG. 3 partially impregnated with an impregnating liquid.

FIG. 6 is an enlarged view of the region shown by arrow A of the liquid-impregnated surface of FIG. 3.

FIG. 7a-b is a schematic diagram of a liquid droplet placed on a liquid-impregnated surface, according to an embodiment. FIG. 7c-d show photographs of a water droplet on a liquid-impregnated surface. FIGS. 7e-f are laser confocal microscopy images and FIGS. 7i-j are ESEM images of a liquid-impregnated surface according to an embodiment.

FIG. 8 shows schematics of wetting configurations outside and underneath a droplet.

FIG. 9 shows possible thermodynamic states of a water droplet placed on a liquid-impregnated surface.

FIG. 10a shows measured roll off angles of different liquid-impregnated surfaces. FIG. 10b shows SEM images of a liquid-impregnated surface with solid features and FIG. 10c shows SEM images of liquid-impregnated surfaces with hierarchical solid features. FIG. 10d shows the non-dimensional plot of scaled gravitational force at the instant of roll-off as a function of the relevant pinning force of the liquid-impregnated surfaces of FIG. 10a.

FIG. 11a shows measured velocities of water droplets as a function of substrate tilt angle. FIG. 11b shows a schematic of a water droplet moving on a liquid-impregnated surface showing the various parameters considered in the scaling model, described herein. FIG. 11c shows trajectories of a number of coffee particles measured relative to the water droplet on a liquid-impregnated surface, according to an embodiment. FIG. 11d shows a non-dimensional plot obtained from the model described herein.

FIG. 12a shows condensation of water droplets on a first liquid-impregnated surface that includes a 100 cSt silicon oil as an impregnating liquid. FIG. 12b shows an enlarged view of a portion of the first liquid-impregnated surface. FIG. 12c shows condensation of water droplets on a second liquid-impregnated surface that includes a 10 cSt silicone oil as the impregnating liquid.

FIG. 13A shows an untreated surface with a liquid droplet, which includes dissolved gases, disposed on it. FIG. 13b shows a liquid-impregnated surface with droplets of the same liquid disposed on it.

FIG. 14A shows an untreated beer glass having a commercially available beer disposed in it. FIG. 14B shows a substantially similar glass configured to define a liquid-impregnated surface and having the same commercially available beer disposed in it.

### DETAILED DESCRIPTION

Some known surfaces with designed chemistry and roughness, possess substantial non-wetting (hydrophobic) properties which can be extremely useful in a wide variety of commercial and technological applications. Some hydrophobic surfaces are inspired by nature, such as for example, the lotus plant which includes air pockets trapped within the micro or nano-textures of the surface, increasing the contact angle of a contact liquid (e.g., water or any other aqueous liquid) disposed on the hydrophobic surface. As long as these air pockets are stable, the surface continues to exhibit hydrophobic behavior. Such known hydrophobic surfaces that include air pockets, however, present certain limitations including, for example: i) the air pockets can be collapsed by external wetting pressures, ii) the air pockets can diffuse away into the surrounding liquid, iii) the surface can lose robustness upon damage to the texture, iv) the air pockets may be displaced by low surface tension liquids unless special texture design is implemented, and v) condensation or frost nuclei, which can form at the nanoscale throughout the texture, can completely transform the wetting properties and render the textured surface highly wetting.

Non-wetting surfaces can also be formed by disposing a liquid-impregnated surface on a substrate. Such liquid-impregnated surfaces can be nonwetting to any liquid, i.e. omniphobic (e.g. super hydrophobic, super oleophobic, or super metallophobic), can be configured to resist ice and frost formation, and can be highly durable. Liquid-impregnated surfaces can be disposed on any substrate, for example, on the inner surface of pipes, containers, or vessels, and can be configured to present a non-wetting surface to a wide variety of products, for example, food products, pharmaceuticals, over-the-counter drugs, nutraceuticals, health and beauty products, industrial greases, inks, bitumen, cement, adhesives, hazardous waste, consumer products, or any other product, such that the product can be evacuated, detached, or otherwise displaced with substantial ease on the liquid-impregnated surface.

Liquid-impregnated surfaces described herein, include impregnating liquids that are impregnated into a rough surface that includes a matrix of solid features defining interstitials regions, such that the interstitial regions include pockets of impregnating liquid. The impregnating liquid is configured to wet the solid surface preferentially and adhere to the micro-nano textured surface with strong capillary forces, such that the contact liquid has an extremely high advancing contact angle and an extremely low roll off angle (e.g., a roll off angle of about 1 degree and a contact angle of greater than about 100 degrees). This enables the contact liquid to displace with substantial ease on the liquid-impregnated surface. Therefore, the liquid-impregnated surfaces described herein, provide certain significant advantages over conventional super hydrophobic surfaces including: i) the liquid-impregnated surfaces creates a low hysteresis for the product, ii) such liquid-impregnated surfaces can include self cleaning properties, iii) can withstand high drop impact pressure (i.e., are wear resistant), iv) can self heal by capillary wicking upon damage, v) can repel a variety of contact liquids, such as semisolids, slurries, mixtures and/or non-Newtonian fluids, for example, water, edible liquids or formulations (e.g., ketchup, catsup, mustard, mayonnaise, syrup, honey, jelly, etc.), environmental fluids (e.g., sewage, rain water), bodily fluids (e.g., urine, blood, stool), or any other fluid (e.g. hair gel, toothpaste), vi) can reduce ice formation, vii) enhance condensation, viii) allow mold release, ix) prevent corrosion, x) reduce ice or gas hydrate adhesion, xi) prevent scaling from salt or mineral deposits, xii) reduce biofouling, and xiii) enhance condensation. Furthermore, the liquid-impregnated surfaces described herein can substantially reduce the number of nucleation sites. This can substantially inhibit nucleation vapor and/or gas bubbles dissolved in a contact liquid, for example, a carbonated beverage, a boiling liquid, or a flowing liquid, on the liquid-impregnated surface. In this manner, the liquid-impregnated surface can reduce fizzing and prevent carbonated beverages from going flat, inhibit boiling (e.g., because of heating or reduction in pressure), or prevent cavitation.

Examples of liquid-impregnated surfaces, methods of making liquid-impregnated surfaces and applications thereof, are described in U.S. Pat. No. 8,574,704, entitled “Liquid-Impregnated Surfaces, Methods of Making, and Devices Incorporating the Same,” filed Aug. 16, 2012, the entire contents of which are hereby incorporated by reference herein. Examples of materials used for forming the solid features on the surface, impregnating liquids, and applications involving edible contact liquids, are described in U.S. Pat. No. 8,535,779, entitled “Self-Lubricating Surfaces for Food Packaging and Food Processing Equipment,” issued Sep. 17, 2013, the entire contents of which are hereby incorporated by reference herein. Examples of non-toxic liquid-impregnated surfaces are described in U.S. Provisional Application No. 61/878,481, (the '481 application) entitled “Non-toxic Liquid-Impregnated Surfaces”, filed Sep. 16, 2013, the entire contents of which are hereby incorporated by reference herein.

In some embodiments, an apparatus having a liquid-impregnated surface includes a first surface having a first roll off angle. A plurality of solid features are disposed on the first surface such that interstitial regions are defined between the solid features. An impregnating liquid is disposed in the interstitial regions which are dimensioned and configured to remain impregnated by the impregnating liquid through capillarity. The impregnating liquid disposed in the interstitial regions at least partially defines a second surface having a second roll off angle less than the first roll off angle. Furthermore, the second surface has substantially less nucleation sites for formation of bubbles in a contact liquid that includes a gas dissolved therein and is disposed on the second surface, as compared to the first surface. In some embodiments, the contact liquid is carbonated. In some embodiments, the contact liquid is nitrogenated.

In some embodiments, a vessel for heating a liquid and having a liquid-impregnated surface includes a first surface having a first roll off angle. A plurality of solid features are disposed on the first surface such that interstitial regions are defined between the plurality of solid features. An impregnating liquid is disposed between the interstitial regions which are dimensioned and configured to remain impregnated by the impregnating liquid through capillarity. The impregnating liquid disposed in the interstitial regions at least partially defines a second surface having a second roll off angle less than the first roll off angle. Furthermore, the second surface has substantially less nucleation sites for formation of bubbles in a contact liquid that is disposed on the second surface and is heated to release a gas dissolved in the contact liquid, as compared to the first surface.

In some embodiments, an apparatus having a liquid-impregnated surface includes a hub rotatable about a central axis. At least one blade is connected to the hub. The blade include parts including a leading edge, a trailing edge, a fillet, a face, and a back. Each part includes a first surface having a first roll off angle. A plurality of solid features are disposed on the first surface of at least one part of the blade such that interstitial regions are defined between the plurality of solid features. An impregnating liquid is disposed between the interstitial regions which are dimensioned and configured to remain impregnated by the impregnating liquid through capillarity. The impregnating liquid disposed in the interstitial regions at least partially defines a second surface of the at least one part of the blade, having a second roll off angle less than the first roll off angle. Furthermore, the second surface has substantially less cavitation in a contact liquid in contact with the second surface, as compared to the first surface. In some embodiments, the apparatus can be a propeller or an impeller.

As used herein, the term “about” and “approximately” generally mean plus or minus 10% of the value stated, for example about 250 μm would include 225 μm to 275 μm, about 1,000 μm would include 900 μm to 1,100 μm.

As used herein, the term “contact liquid”, “bulk material, and “product” are used interchangeably to refer to a solid or liquid that flows, for example a non-Newtonian fluid, a Bingham fluid, a high viscosity fluids, or a thixotropic fluid and is contact with a liquid-impregnated surface, unless otherwise stated.

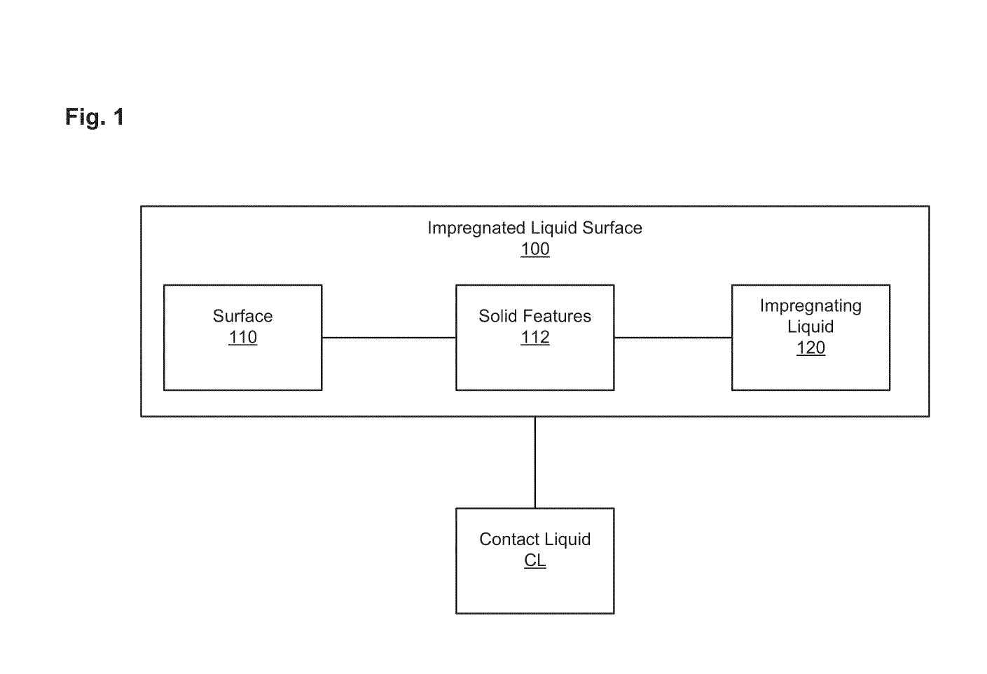

FIG. 1 illustrates a schematic block diagram of a liquid-impregnated surface 100. The liquid-impregnated surface includes a surface 110, a plurality of solid features 112 and an impregnating liquid 120. The impregnating liquid 120 is impregnated into the interstitial regions defined by the plurality of solid features 112. The liquid-impregnated surface can be in contact with a contact liquid CL, such that the contact liquid CL can easily move over the liquid-impregnated surface 100.

In some embodiments, the surface 110 can be an inner surface of a container. The container can include any suitable container such as, for example, tubes, bottles, vials, flasks, molds, jars, tubs, cups, caps, glasses, pitchers, barrels, bins, totes, tanks, kegs, tubs, syringes, tins, pouches, lined boxes, hoses, cylinders, and cans. In such embodiment, the container can be constructed in almost any desirable shape. The container can be constructed of rigid or flexible materials. Foil-lined or polymer-lined cardboard or paper boxes can also be used to form the container. In some embodiments, the surface 110 can include a surface of hoses, piping, conduit, nozzles, syringe needles, dispensing tips, lids, pumps, and other surfaces for containing, transporting, or dispensing the contact liquid CL. The surface 110 can be formed from any suitable material including, for example plastic, glass, metal, alloys, ceramics, coated fibers, any other material, or combinations thereof. Suitable surfaces can include, for example, polystyrene, nylon, polypropylene, wax, fluorinated wax, natural waxes, siliconyl waxes, polyethylene terephthalate, polypropylene, poly propylene carbonate, poly imide, polyethylene, polyurethane, graphene, polysulphone, polyethersulfone, polytetrafluoroethylene (PTFE), tetrafluoroethylene (TFE), fluorinated ethylenepropylene copolymer (FEP), polyvinylidene fluoride (PVDF), perfluoroalkoxytetrafluoroethylene copolymer (PFA), perfluoromethyl vinylether copolymer (MFA), ethylenechlorotrifluoroethylene copolymer (ECTFE), ethylene-tetrafluoroethylene copolymer (ETFE), perfluoropolyether(PFPE), polychlorotetrafluoroethylene (PCTFE), polyvinyl alcohol (PVA), polyvinyl acetate (PVAc), polyethyleneglycol (PEG), Polyvinylpyrrolidone (PVP), Polylactic acid (PLA), Acrylonitrile butadiene styrene (ABS), Tecnoflon cellulose acetate, poly(acrylic acid), polypropylene oxide), Dsorbitol, erythritol, xylitol, lactitol, maltitol, mannitol, and polycarbonate.

The solid features 112 can be disposed on the surface 110 using any suitable process. For example, in some embodiments, a top down fabrication process can be used to form the solid features 112 on the surface 110. For example, micro and/or nano-lithography (e.g., photolithography, SU-8 masks, nano imprinting, hard masking, shadow photolithography, etc.) can be used to define the solid features 112 on the surface 110, for example, silicon, glass, chromium, gold, PDMS, parylene, or any other suitable surface. In some embodiments, the micro and/or nano patterns can be used as the features of the solid features 112. In some embodiments, the micro and/or nano-patterns can be used as masks for further etching of the surface 110, for example, wet chemical etching (e.g., using buffered hydrofluoric acid, gold etchant, chromium etchant), or dry etching (e.g., reactive ion etching, deep reactive ion etching, SF₆ etching, electron beam lithography, plasma beam lithography, etc.). In some embodiments, the solid features 112 can be grown in-situ on the surface, for example, using atomic layer deposition (ALD), sputtering, e-beam deposition, chemical vapor deposition, plasma enhanced chemical vapor deposition, and the likes.

In some embodiments, the solid features 112 can be disposed on the inner surface of a container (e.g., any of the containers described herein) or be integral to the surface itself (e.g., the textures of a polycarbonate bottle may be made of polycarbonate). In some embodiments, the solid features 112 may be formed of a collection or coating of particles including, but not limited to insoluble fibers (e.g., purified wood cellulose, micro-crystalline cellulose, and/or oat bran fiber), wax (e.g., carnauba wax, Japan wax, beeswax, candelilla wax, rice bran wax), shellac, fluorinated waxes, siliconyl waxes, other polysaccharides, fructo-oligosaccharides, metal oxides, montan wax, lignite and peat, ozokerite, ceresins, bitumens, petrolatuns, paraffins, microcrystalline wax, lanolin, esters of metal or alkali, flour of coconut, almond, potato, wheat, pulp, zein, dextrin, cellulose ethers (e.g., Hydroxyethyl cellulose, Hydroxypropyl cellulose (HPC), Hydroxyethyl methyl cellulose, Hydroxypropyl methyl cellulose (HPMC), Ethyl hydroxyethyl cellulose), ferric oxide, ferrous oxide, silicas, clay minerals, bentonite, palygorskite, kaolinite, vermiculite, apatite, graphite, molybdenum disulfide, mica, boron nitride, sodium formate, sodium oleate, sodium palmitate, sodium sulfate, sodium alginate, agar, gelatin, pectin, gluten, starch alginate, carrageenan, whey and/or any other edible solid particles described herein or any combination thereof.

In some embodiments, surface energy of the surface 110 and/or the solid features 112 can be modified, for example, to enhance the adhesion of the solid features 112 to the surface 110 or to enhance the adhesion of the impregnating liquid 120 to the solid features 112 and/or the surface 110. Such surface modification processes can include, for example, sputter coating, silane treatment, fluoro-polymer treatment, anodization, passivation, chemical vapor deposition, physical vapor deposition, oxygen plasma treatment, electric arc treatment, thermal treatment, any other suitable surface chemistry modification process or combination thereof.

In some embodiments, the solid features 112 can be disposed by exposing the surface 110 (e.g., polycarbonate) to a solvent (e.g., acetone). For example, the solvent may impart texture by inducing crystallization (e.g., polycarbonate may recrystallize when exposed to acetone). In some embodiments, the solid features 112 can be disposed by dissolving, etching, melting, reacting, treating, or spraying on a foam or aerated solution, exposing the surface to electromagnetic waves such as, for example ultraviolet (UV) light or microwaves, or evaporating away a portion of a surface, leaving a textured, porous, and/or rough surface behind that includes a plurality of the solid features 112. In some embodiments, the solid features 112 can be defined by mechanical roughening (e.g., tumbling with an abrasive, sandblasting, sanding), spray-coating or polymer spinning, plasma spraying, thermal spraying, deposition of particles from solution (e.g., layer-by-layer deposition, evaporating away liquid from a liquid/particle suspension contacting the surface), and/or extrusion or blow-molding of a foam, or foam-forming material (for example a polyurethane foam). In some embodiments, the solid features 112 can also be formed by deposition of a polymer from a solution (e.g., the polymer forms a rough, porous, or textured surface); extrusion or blow-molding of a material that expands upon cooling, leaving a wrinkled surface; and application of a layer of a material onto a surface that is under tension or compression, and subsequently relaxing the tension or compression of surface beneath, resulting in a textured surface.

In some embodiments, the solid features 112 can be formed by disposing a material, for example, a porous media on the surface capable of forming a layer of the material on the surface that includes pores of different sizes, and/or self-assembles on the surface 110. For example, in some embodiments, the solid features 112 are disposed through non-solvent induced phase separation of a polymer, resulting in a sponge-like porous structure. This can include, for example, a solution of polysulfone, poly(vinylpyrrolidone), and DMAc may be cast onto a substrate and then immersed in a bath of water. Upon immersion in water, the solvent and non-solvent exchange, and the polysulfone precipitates and hardens. The material can be disposed on the surface 110 by any suitable method, for example, spray coating, immersion (dip) coating, vapor deposition, pouring and/or any other suitable method to form the textured surface 110.

The solid features 112 can include micro-scale features such as, for example posts, pillars, spheres, nano-needles, pores, cavities, interconnected pores, grooves, ridges, spikes, peaks, interconnected cavities, bumps, mounds, particles, particle agglomerations, or any other random geometry that provides a micro and/or nano surface roughness. In some embodiments, the solid features 112 can include particles that have micro-scale or nano-scale dimensions which can be randomly or uniformly dispersed on a surface. Characteristic spacing between the solid features 112 can be about 1 mm, about 900 μm, about 800 μm, about 700 μm, about 600 μm, about 500 μm, about 400, μm, about 300 μm, about 200 μm, about 100 μm, about 90 μm, about 80 μm, about 70 μm, about 60 μm, about 50 μm, about 40 μm, about 30 μm, about 20 μm, about 10 μm, about 5 μm, 1 μm, or 100 nm, about 90 nm, about 80 nm, about 70 nm, about 60 nm, about 50 nm, about 40 nm, about 30 nm, about 20 nm, about 10 nm, or about 1 nm. In some embodiments, characteristic spacing between the solid features 112 can be in the range of about 100 μm to about 100 nm, about 30 μm to about 1 μm, or about 10 μm to about 1 μm. In some embodiments, characteristic spacing between solid features 112 can be in the range of about 100 μm to about 80 μm, about 80 μm to about 50 μm, about 50 μm to about 30 μm, about 30 μm to about 10 μm, about 10 μm to about 1 μm, about 1 μm to about 90 nm, about 90 nm to about 70 nm, about 70 nm to about 50 nm, about 50 nm to about 30 nm, about 30 nm, to about 10 nm, or about 10 nm to about 1 nm, inclusive of all ranges therebetween.

In some embodiments, the solid features 112, for example solid particles can have an average dimension of about 200 μm, about 100 μm, about 90 μm, about 80 μm, about 70 μm, about 60 μm, about 50 μm, about 40 μm, about 30 μm, about 20 μm, about 10 μm, about 5 μm, 1 μm, about 100 nm, about 90 nm, about 80 nm, about 70 nm, about 60 nm, about 50 nm, about 40 nm, about 30 nm, about 20 nm, about 10 nm, or about 1 nm. In some embodiments, the average dimension of the solid features 112 can be in the range of about 100 μm to about 100 nm, about 30 μm to about 10 μm, or about 20 μm to about 1 μm. In some embodiments, the average dimension of the solid feature 112 can be in the range of about 100 μm to about 80 μm, about 80 μm to about 50 μm, about 50 μm to about 30 μm, or about 30 μm to about 10 μm, or 10 μm to about 1 μm, about 1 μm to about 90 nm, about 90 nm to about 70 nm, about 70 nm to about 50 nm, about 50 nm to about 30 nm, about 30 nm, to about 10 nm, or about 10 nm to about 1 nm, inclusive of all ranges therebetween. In some embodiments, the height of the solid features 112 can be substantially uniform. In some embodiments, the surface 110 can have hierarchical features. For example the solid features can include micro-scale features that further include nano-scale features disposed thereupon.

In some embodiments, the solid features 112 (e.g., particles) can be porous. Characteristic pore size (e.g., pore widths or lengths) of particles can be about 5,000 nm, about 3,000 nm, about 2,000 nm, about 1,000 nm, about 500 nm, about 400 nm, about 300 nm, about 200 nm, about 100 nm, about 80 nm, about 50 nm, about 10 nm, or about 1 nm, inclusive of all ranges therebetween. In some embodiments, characteristic pore size can be in the range of about 200 nm to about 2 μm, or about 10 nm to about 1 μm inclusive of all ranges therebetween. Controlling the pore size, the length of pores, and the number of pores can allow for greater control of the impregnating liquid flow rates, product flow rates, and overall material yield.

The impregnating liquid 120 is disposed on the surface 110 such that the impregnating liquid 120 impregnates the interstitial regions defined by the plurality of solid features 112, for example, pores, cavities, or otherwise inter-feature spacing defined by the surface 110 such that no air remains in the interstitial regions. The interstitial regions can be dimensioned and configured such that the surface remains impregnated by impregnating liquid 120 through capillarity. The impregnating liquid 120 disposed in the interstitial regions of the plurality of solid features 112 is configured to define a second roll off angle less than the first roll of angle (i.e., the roll of angle of the unmodified surface 110. In some embodiments, the impregnating liquid 120 can have a viscosity at room temperature of less than about 1,000 cP, for example about 1 cP, 10 cP, 20 cP, 50 cP, about 100 cP, about 150 cP, about 200 cP, about 300 cP, about 400 cP, about 500 cP, about 600 cP, about 700 cP, about 800 cP, about 900 cP, or about 1,000 cP, inclusive of all ranges therebetween. In some embodiments, the impregnating liquid 120 can have viscosity of less than about 1 cP, for example, about 0.1 cP, 0.2 cP, 0.3 cP, 0.4 cP, 0.5 cP, 0.6 cP, 0.7 cP, 0.8 cP, 0.9 cP, or about 0.99 cP, inclusive of all ranges therebetween. In some embodiments, the impregnating liquid 120 can fill the interstitial regions defined by the solid features 112 such that the impregnating liquid 120 forms a layer at least about 5 nm thick above the plurality of solid features 112 disposed on the surface 110. In some embodiments, the impregnating liquid 120 forms a layer at least about 100 nm thick above the plurality of solid features 112 disposed on the surface 110. In some embodiments, the impregnating liquid 120 forms a layer at least about 1 um thick above the plurality of solid features 112 disposed on the surface 110. In some embodiments the plurality of solid features can have an average roughness, Ra, less than 0.8 um, for example, in compliance with the rules and regulations of a regulatory body (e.g., the Food and Drug Administration (FDA)).

The impregnating liquid 120 may be disposed in the interstitial spaces defined by the solid features 112 using any suitable means. For example, the impregnating liquid 120 can be sprayed (e.g., air spray, thermal spray, plasma spray) or brushed onto the textured surface 110 (e.g., a texture on an inner surface of a bottle). In some embodiments, the impregnating liquid 120 can be applied to the textured surface 110 by filling or partially filling a container that includes the textured surface 110. The excess impregnating liquid 120 is then removed from the container. In some embodiments, the excess impregnating liquid 120 can be removed by adding a wash liquid (e.g., water, surfactants, acids, bases, solvents, etc.), or a heated wash liquid to the container to collect or extract the excess liquid from the container. In some embodiments, the excess impregnating liquid may be mechanically removed (e.g., pushed off the surface with a solid object or fluid), absorbed off of the surface 110 using another porous material, or removed via gravity or centrifugal forces. In some embodiments, the impregnating liquid 120 can be disposed by spinning the surface 110 (e.g., a container) in contact with the liquid (e.g., a spin coating process), and condensing the impregnating liquid 120 onto the surface 110. In some embodiments, the impregnating liquid 120 is applied by depositing a solution with the impregnating liquid and one or more volatile liquids (e.g., via any of the previously described methods) and evaporating away the one or more volatile liquids. In some embodiments, the solid materials may be removed in a wash process, and reapplied after the wash process.

In some embodiments, the impregnating liquid 120 can be applied using a spreading liquid that spreads or pushes the impregnating liquid along the surface 110. For example, the impregnating liquid 120 (e.g., ethyl oleate) and spreading liquid (e.g., water) may be combined in a container and agitated or stirred. The fluid flow within the container may distribute the impregnating liquid 120 around the container as it impregnates the solid features 112.

In some embodiments, the impregnating liquid 120 included in the liquid-impregnated surface 100 can be saturated with the solid features 112 (e.g., any of the solid features described herein) such that the solid features 112 do not dissolve into the impregnating liquid 120.

In some embodiments, the impregnating liquid 120 can include, silicone oil, a perfluorocarbon liquid, halogenated vacuum oil, greases, lubricants, (such as Krytox 1506 or Fromblin 06/6), a fluorinated coolant (e.g., perfluoro-tripentylamine sold as FC-70, manufactured by 3M), a high temperature heat transfer fluid (e.g. Galden HT 200 or Galden HT 270, Novec fluids, etc.), an ionic liquid, a fluorinated ionic liquid that is immiscible with water, a silicone oil comprising PDMS, a fluorinated silicone oil such as, for example polyfluorosiloxane, or polyorganosiloxanes, a liquid metal, a synthetic oil, a vegetable oil, derivative of a vegetable oil, a mono- di- or triglyceride, an electro-rheological fluid, a magneto-rheological fluid, a ferro-fluid, a dielectric liquid, a hydrocarbon liquid such as mineral oil, polyalphaolefins (PAO), fluorinated glycine, fluorinated ethers, or other synthetic hydrocarbon co-oligomers, a fluorocarbon liquid, for example, polyphenyl ether (PPE), perfluoropolyether (PFPE), or perfluoroalkanes, a refrigerant, a vacuum oil, a phase-change material, a semi-liquid, polyalkylene glycol, esters of saturated fatty and dibasic acids, polyurea, grease, synovial fluid, bodily fluid, or any other aqueous fluid or any other impregnating liquid described herein. In some embodiments, the impregnating liquid 120 can include an ionic liquid. Such ionic impregnating liquids can include, for example, tetrachloroethylene (perchloroethylene), phenyl isothiocyanate (phenyl mustard oil), bromo benzene, iodobenzene, obromotoluene, alpha-chloronaphthalene, alpha-bromonaphthalene, acetylene tetrabromide, 1-butyl-3-methylimidazolium bis(trifluoromethylsulfonyl) imide (BMim), tribromohydrin (1,2,3-tribromopropane), tetradecane, cyclohexane, ethylene dibromide, carbon disulfide, bromoform, methylene iodide (diiodomethane), stanolax, Squibb's liquid petrolatum, p-bromotoluene, monobromobenzene, perchloroethylene, MCT oil, carbon disulfide, phenyl mustard oil, monoiodobenzene, triacetin, triglyceride of citric acid, alpha-monochloro-naphthalene, acetylene tetrabromide, aniline, butyl alcohol, isoamyl alcohol, n-heptyl alcohol, cresol, oleic acid, linoleic acid, amyl phthalate, any other ionic liquid and any combination thereof.

In some embodiments, the liquid-impregnated surface 100 can include non-toxic materials, for example impregnating liquid 120 and/or solid 112 (e.g., solid particles used to form solid features such as, for example, wax) which are non-toxic to humans and/or animals. Such non-toxic liquid-impregnated surfaces can thereby be disposed on surfaces, for example the interior surface of containers, which are configured to house products formulated for human use or consumption. Such products can include, for example food products, drugs (e.g., FDA approved drugs), or health and beauty products.

In some embodiments, any solvents used in the processing of any components of the liquid-impregnated surface 100, for example the solid surface, may remain in the liquid-impregnated surface in some concentration, and thus the solvents can also be chosen to be non-toxic. Examples of solvents that are nontoxic in residual quantities include ethyl acetate, ethanol, or any other non-toxic solvent.

The non-toxicity requirements can vary depending upon the intended use of the product in contact with the liquid-impregnated surface. For example, liquid-impregnated surfaces configured to be used with food products or products classified as drugs would be required to have a much higher level of non-toxicity when compared with products meant to contact only the oral mucosa (e.g., toothpaste, mouth wash, etc.), or applied topically such as, for example, health and beauty products (e.g., hair gel, shampoo, cosmetics, etc.).

In some embodiments, the liquid-impregnated surface 100 can include materials that are a U.S. Food and Drug Administration (FDA) approved direct or indirect food additive, an FDA approved food contact substance, satisfy FDA regulatory requirements to be used as a food additive or food contact substance, and/or is an FDA GRAS material. Examples of such materials can be found within the FDA Code of Federal Regulations Title 21, located at “http://www.accessdata.fda.gov/scripts/cdrh/cfdocs/cfcfr/cfrsearch.cfm”, the entire contents of which are hereby incorporated by reference herein. In some embodiments, the components of the liquid-impregnated surface 100, for example the impregnating liquid can exist as a component of the food product disposed within the container. In some embodiments, the components of the liquid-impregnated surface 100 can include a dietary supplement or ingredient of a dietary supplement. The components of the liquid-impregnated surface 100 can also include an FDA approved food additive or color additive. In some embodiments, the liquid-impregnated surface 10 can include materials that exist naturally in, or are derived from plants and animals. In some embodiments, the liquid-impregnated surface 100 for use with food products includes solids or impregnating liquid that is flavorless or have a high flavor threshold of below 500 ppm, are odorless or have high odor threshold, and/or are substantially transparent.

In some embodiments, the materials included in the liquid-impregnated surface 100 can include an FDA approved drug ingredient, for example any ingredient included in the FDA's database of approved drugs, “http://www.accessdata.fda.gov/scripts/cder/drugsatfda/index.cfm”, the entire contents of which are hereby incorporated herein by reference. In some embodiments, the liquid-impregnated surface 100 can include materials that satisfy FDA requirements to be used in drugs or are listed within the FDA's National Drug Discovery Code Directory, “http://www.accessdata.fda.gov/scripts/cder/ndc/default.cfm”, the entire contents of which are hereby incorporated herein by reference. In some embodiments, the materials can include inactive drug ingredient of an approved drug product as listed within FDA's database, “http://www.accessdata.fda.gov/scripts/cder/ndc/default.cfm”, the entire contents of which are hereby incorporated herein by reference. In some embodiments, the materials can include any materials that satisfy the requirement of materials that can be used in liquid-impregnated surfaces configured to be used with food products, and/or include a dietary supplement or ingredient of a dietary supplement.

In such embodiments, the liquid-impregnated surface 100 can include materials which are FDA approved and satisfies FDA drug requirements as are listed within the FDA's National Drug Discovery Code Directory and can also include FDA approved health and beauty ingredient, that satisfy FDA requirements to be used in health and beauty products, satisfies FDA regulatory laws included in the Federal Food, Drug and Cosmetic Act (FD&C Act), or the Fair Packaging and Labeling Act (FPLA).

In some embodiments, the liquid-impregnated surface 100 can include materials that are an FDA approved health and beauty ingredient, that satisfies FDA requirements to be used in health and beauty products, satisfies FDA regulatory laws included in the Federal Food, Drug and Cosmetic Act (FD&C Act), or the Fair Packaging and Labeling Act (FPLA). In some embodiments, the materials can include a flavor or a fragrance.

In some embodiments, the materials included in the liquid-impregnated surfaces 100 described can be flavorless or have high flavor thresholds below 500 ppm, and can be odorless or have a high odor threshold. In some embodiments the materials included in the liquid-impregnated surface 100 can be substantially transparent. For example, the solid features 112 or impregnating liquid 120 can be selected so that they have substantially the same or similar indices of refraction. By matching their indices of refraction, they may be optically matched to reduce light scattering and improve light transmission. For example, by utilizing materials that have similar indices of refraction and have a clear, transparent property, a surface having substantially transparent characteristics can be formed. In some embodiments, the materials included in the liquid-impregnated surface 100 are organic or derived from organically grown products. In some embodiments, the impregnating liquid 120 can include one or more additives. The additive can be configured, for example, to reduce the viscosity, vapor pressure, or solubility of the impregnating liquid. In some embodiments, the additive can be configured to increase the chemical stability of the liquid-impregnated surface, for example the additive can be an anti-oxidant configured to inhibit oxidation of the liquid-impregnated surface. In some embodiments the additive can be added to reduce or increase the freezing point of the liquid. In some embodiments, the additive can be configured to reduce the diffusivity of oxygen or CO₂ through the liquid-impregnated surface or enable the liquid-impregnated surface to absorb more ultra violet (UV) light, for example protect the product (e.g., any of the products described herein), disposed within a container on which the non-toxic liquid-impregnated surface is disposed. In some embodiments, the additive can be configured to provide an intentional odor, for example a fragrance (e.g., smell of flowers, fruits, plants, freshness, scents, etc.). In some embodiments, the additive can be configured to provide color to the liquid-impregnated surface and can include, for example a dye, or an FDA approved color additive. In some embodiments, the non-toxic liquid-impregnated surface includes an additive that can be released into the product, for example, a flavor or a preservative.

In some embodiments, the materials included in any of the liquid-impregnated surface 100 can be organic or derived from organically grown products. For example, the impregnating liquid 120 can include organic liquids that are often or sometimes non-toxic. Such organic liquids can, for example, include materials that fall within the following classes; lipids, vegetable oils (e.g., olive oil, light olive oil, corn oil, soybean oil, rapeseed oil, linseed oil, grapeseed oil, flaxseed oil, peanut oil, safflower oil, palm oil, coconut oil, or sunflower oil), fats, fatty acids, derivatives of vegetable oils or fatty acids, esters, terpenes, monoglycerides, diglycerides, triglycerides, alcohols, and fatty acid alcohols. Examples of vegetable oils suitable for use as impregnating liquid 120 are described in Gunstone, F., “Vegetable Oils in Food Technology: Composition, Properties and Uses: 2^{nd} Ed.”, Wiley, John and Sons Inc., Pub. May 2011, the contents of which are hereby incorporated by reference herein in their entirety.

In some embodiments, the liquid-impregnated surface '00 described herein can include organic solids and/or liquids that are non-toxic and fall within the following classes; lipids, waxes, fats, fibers, cellulose, derivatives of vegetable oils, esters (such as esters of fatty acids), terpenes, monoglycerides, diglycerides, triglycerides, alcohols, fatty acid alcohols, ketones, aldehydes, proteins, sugars, salts, minerals, vitamins, carbonate, ceramic materials, alkanes, alkenes, alkynes, acyl halides, carbonates, carboxylates, carboxylic acids, methoxies, hydroperoxides, peroxides, ethers, hemiacetals, hemiaketals, acetals, ketals, orthoesters, orthocarbonate esters, phospholipids, lecithins, any other organic material or any combination thereof. In some embodiments, any of the non-toxic liquid-impregnated surfaces described herein can include non-toxic materials that are boron, phosphorous, or sulfur containing compound. Some examples of food-safe impregnating liquids are MCT (medium chain triglyceride) oil, ethyl oleate, methyl laurate, propylene glycol dicaprylate/dicaprate, or vegetable oil, glycerine, squalene. In some embodiments, any of the non-toxic liquid-impregnated surfaces can include inorganic materials, for example ceramics, metals, metal oxides, silica, glass, plastics, any other inorganic material or combination thereof. In some embodiments, any of the non-toxic liquid-impregnated surfaces described herein can include, for example preservatives, sweeteners, color additives, flavors, spices, flavor enhancers, fat replacers, and components of formulations used to replace fats, nutrients, emulsifiers, surfactants, bulking agents, cleansing agents, depilatories, stabilizers, emulsion stabilizers, thickeners, flavor or fragrance, an ingredient of a flavor or fragrance, binders, texturizers, humectants, pH control agents, acidulants, leavening agents, anti-caking agents, anti-dandruff agents, anti-microbial agents, anti-perspirants, anti-seborrheic agents, astringents, bleaching agents, denaturants, depilatories, emollients, foaming agents, hair conditioning agents, hair fixing agents, hair waving agents, absorbents, anti-corrosive agents, anti-foaming agents, anti-oxidants, anti-plaque agents, anti-static agents, binding agents, buffering agents, chelating agents, cosmetic colorants, deodorants, detangling agents, emulsifying agents, film formers, foam boosting agents, gel forming agents, hair dyeing agents, hair straightening agents, keratolytics, moisturizing agents, oral care agents, pearlescent agents, plasticizers, refatting agents, skin conditioning agents, smoothing agents, soothing agents, tonics, and/or UV filters.

In some embodiments, the liquid-impregnated surface 100 can include non-toxic materials having an average molecular weight in the range of about 100 g/mol to about 600 g/mol. which are included in the Springer Material Landolt-Bornstein database located at, “http://www.springermaterials.com/docs/index.html”, or in the MatNavi database located at “www.mits.nims.go.jp/index_en.html”. In some embodiments, the impregnating liquid 120 can have a boiling point greater than 150° C. or preferably 250° C., such that the impregnating liquid 120 is not classified as volatile organic compounds (VOC's). In some embodiments, the impregnating liquid 120 can have a density which is substantially equal to the density of the product.

The ratio of the solid features 112 (e.g., particles) to the impregnating liquid 120, can be configured to ensure that little or no portion of the solid features 112 protrude above the impregnating liquid-contact liquid interface. For example, in some embodiments, a ratio of the solid features 112 to the impregnating liquid 120 on the surface 110 can be less than about 15%, or less than about 5%. In some embodiments, the ratio of the solid features 112 to the projected area of the liquid-impregnating liquid 120 can be less than about 50%, about 45%, about 40%, about 35%, about 30%, about 25%, about 20%, about 15%, about 10%, about 5%, or less than about 2%. In some embodiments, the ratio of the solid features 112 to the impregnating liquid 120 can be in the range of about 5% to about 50%, about 10% to about 30%, or about 15% to about 20%, inclusive of all ranges therebetween. In some embodiments, a low ratio can be achieved using surface textures that are substantially pointed, caved, or are rounded. By contrast, surface textures that are flat may result in higher ratios, with too much solid material exposed at the surface.

In some embodiments, the liquid-impregnated surface 100 can have an “emerged area fraction” q, which is defined as a representative fraction of the projected surface area of the liquid-impregnated surface 112, corresponding to non-submerged solid (non-submerged by the impregnating liquid. This portion can be in contact with a contact liquid) at room temperature, of less than about 0.50, about 0.50, about 0.30, about 0.25, about 0.20, about 0.15, about 0.10, about 0.05, about 0.01, or less than about 0.005. In some embodiments, φ can be greater than about 0.001, about 0.005, about 0.01, about 0.05, about 0.10, about 0.15, or greater than about 0.20. In some embodiments, φ can be in the range of about 0 to about 0.25. In some embodiments, φ can be in the range of about 0 to about 0.01. In some embodiments, φ can be in the range of about 0.001 to about 0.25. In some embodiments, φ can be in the range of about 0.001 to about 0.10.

In some embodiments, the liquid-impregnated surface 100 can have a spreading coefficient Sₒₑ₍ᵥ₎<0, where Sₒₑ₍ᵥ₎ is spreading coefficient, defined as γₑᵥ−γₑₒ−γₒᵥ, where γ is the interfacial tension between the two phases designated by subscripts, said subscripts selected from e, v, and o, where e is a non-vapor phase (e.g., liquid or semi-solid) external to the surface and different from the impregnating liquid, v is vapor phase external to the surface (e.g., air), and o is the impregnating liquid.

In some embodiments, the solid features 112 provide stable impregnation of the impregnating liquid 120 therebetween or therewithin, such that θ_{os(v),receding}<θ_{c} where θ_{c} is critical contact angle. In some embodiments, the solid features 112 can provide stable impregnation of the impregnating liquid 120 therebetween or therewithin, such that: (i) θ_{os(w),receding}=0; and/or (ii) θ_{os(v),receding}=0 and θ_{os(w),receding}=0, where θ_{os(w),receding} is receding contact angle of the impregnating liquid 120 (e.g., oil, subscript ‘o’) on the surface 100 (subscript ‘s’) in the presence of water (subscript ‘w’), and where θ_{os(v),receding} is receding contact angle of the impregnating liquid 120 (e.g., oil, subscript ‘o’) on the surface 100 (subscript ‘s’) in the presence of vapor phase (subscript ‘v’, e.g., air). In some embodiments, the solid features 112 provide stable impregnation of the impregnating liquid 120 therebetween or therewithin, such that: (i) θ_{os(v), receding}>0; and/or (ii) θ_{os(w), receding}>0, where θ_{os(v),receding} is receding contact angle of the impregnating liquid 120 (e.g., oil, subscript ‘o’) on the surface 100 (subscript ‘s’) in the presence of vapor phase (subscript ‘v’, e.g., air), and where θ_{os(w),receding} is receding contact angle of the impregnating liquid 120 (e.g., oil, subscript ‘o’) on the surface 100 (subscript ‘s’) in the presence of water (subscript ‘w’). In some embodiments, both θ_{os(v), receding}>0 and θ_{os(w), receding}>0. In some embodiments, the solid features 112 provide stable impregnation of the impregnating liquid 120 therebetween or therewithin, such that: (i) θ_{os(v),receding}<θ_{c}; and/or (ii) θ_{os(w),receding}<θ_{c}, where θ_{c} is critical contact angle. In some embodiments, the solid features 112 provide stable impregnation of the impregnating liquid 120 therebetween or therewithin, such that: (i) θ_{os(v),receding}<θ*_{c}; and/or (ii) θ_{os(w),receding}<θ*_{c}, where θ*_{c}=cos⁻¹ (1/r), and where r is roughness of the solid portion of the surface 100.

In some embodiments, the solid features 112 provide stable impregnation of the impregnating liquid 120 therebetween or therewithin, such that θ_{os(v), receding}<θ_{c}. where θ_{c} is critical contact angle. In some embodiments, the solid features 112 can provide stable impregnation of the impregnating liquid 120 therebetween or therewithin, such that: (i) θ_{os(e),receding}=0; and/or (ii) θ_{os(v),receding}=0 and θ_{os(e),receding}=0, where θ_{os(e),receding} is receding contact angle of the impregnating liquid 120 (e.g., oil, subscript ‘o’) on the surface 100 (subscript ‘s’) in the presence of the contact liquid CL (subscript ‘e’), and where θ_{os(v),receding} is receding contact angle of the impregnating liquid 120 (e.g., oil, subscript ‘o’) on the surface 100 (subscript ‘s’) in the presence of vapor phase (subscript e.g., air). In some embodiments, the solid features 112 provide stable impregnation of the impregnating liquid 120 therebetween or therewithin, such that: (i) θ_{os(v), receding}>0; and/or (ii) θ_{os(e), receding}>0, where θ_{os(v),receding} is receding contact angle of the impregnating liquid 120 (e.g., oil, subscript o) on the surface 100 (subscript ‘s’) in the presence of vapor phase (subscript ‘v’, e.g., air), and where θ_{os(w),receding} is receding contact angle of the impregnating liquid 120 (e.g., oil, subscript ‘o’) on the surface 100 (subscript ‘s’) in the presence of the contact liquid CL (subscript ‘e’). In some embodiments, both θ_{os(v), receding}>0 and θ_{os(e), receding}>θ_{c}. In some embodiments, the solid features 112 provide stable impregnation of the impregnating liquid 120 therebetween or therewithin, such that: (i) θ_{os(v),receding}<θ_{c}; and/or (ii) θ_{os(e),receding}<θ_{c}, where θ_{c} is critical contact angle. In some embodiments, the solid features 112 provide stable impregnation of the impregnating liquid 120 therebetween or therewithin, such that: (i) θ_{os(v),receding}<θ*_{c}; and/or (ii) θ_{os(v),receding}<θ*_{c}, where θ*_{c}=cos⁻¹ (1/r), and where r is roughness of the solid portion of the surface 100.

In some embodiments, liquid-impregnated surface 100 can have advantageous droplet roll-off properties that minimize the accumulation of the contacting liquid CL on the surfaces. Without being bound to any particular theory, in some embodiments, a roll-off angle which is the angle of inclination of the liquid-impregnated surface 100 at which a droplet of contact liquid placed on the textured solid begins to move, can be less than about 50°, less than about 40°, less than about 30°, less than about 25°, or less than about 20° for a specific volume of contact liquid. In such embodiments, the roll off angle can vary with the volume of the contact liquid included in the droplet, but for a specific volume of the contact liquid, the roll off angle remains substantially the same.

In some embodiments, the impregnating liquid 120 can include one or more additives to prevent or reduce evaporation of the impregnating liquid 120. For example, a surfactant can be added to the impregnating liquid 120. The surfactants can include, but are not limited to, docosenoic acid, trans-13-docosenoic acid, cis-13-docosenoic acid, nonylphenoxy tri(ethyleneoxy) ethanol, methyl 12-hydroxyoctadecanate, 1-Tetracosanol, fluorochemical “L-1006”, and any combination thereof. Examples of surfactants described herein and other surfactants which can be included in the impregnating liquid can be found in White, I., “Effect of Surfactants on the Evaporation of Water Close to 100 C.” Industrial & Engineering Chemistry Fundamentals 15.1 (1976): 53-59, the content of which is incorporated herein by reference in its entirety. In some embodiments, the additives can include C₁₆H₃₃COOH, C₁₇H₃₃COOH, C₁₈H₃₃COOH, C₁₉H₃₃COOH, C₁₄H₂₉OH, C₁₆H₃₃OH, C₁₈H₃₇OH, C₂₀H₄₁OH, C₂₂H₄₅OH, C₁₇H₃₅COOCH₃, C₁₅H₃₁COOC₂H₅, C₁₆H₃₃OC₂H₄OH, C₁₈H₃₇OC₂H₄OH, C₂₀H₄₁OC₂H₄OH, C₂₂H₄₅OC₂H₄OH, Sodium docosyl sulfate (SDS), poly(vinyl stearate), Poly(octadecyl acrylate), Poly(octadecyl methacrylate) and any combination thereof. Further examples of additives can be found in Barnes, G. T., “The potential for monolayers to reduce the evaporation of water from large water storages”, Agricultural Water Management 95.4 (2008): 339-353, the content of which is hereby by incorporated herein by reference in its entirety.

The liquid-impregnated surface 100 can be in contact with a contact liquid CL such that, the contact liquid CL moves easily over the liquid-impregnated surface 100. The contact liquid CL, can be any liquid or non-Newtonian fluid that is immiscible with the impregnating liquid 120 such as, for example, water, edible liquids or aqueous formulations (e.g., ketchup, mustard, mayonnaise, honey, etc.), environmental fluids (e.g., sewage, rain water), bodily fluids (e.g., urine, blood, stool), or any other fluid. In some embodiments, the contact liquid CL can be a food product or a food ingredient such as, for example, a sticky, highly viscous, and/or non-Newtonian food product. Such food products can include, for example, candy, chocolate syrup, mash, yeast mash, beer mash, taffy, food oil, fish oil, marshmallow, dough, batter, baked goods, chewing gum, bubble gum, butter, peanut butter, jelly, jam, dough, gum, cheese, cream, cream cheese, mustard, yogurt, sour cream, curry, sauce, ajvar, currywurst sauce, salsa lizano, chutney, pebre, fish sauce, tzatziki, sriracha sauce, vegemite, chimichurri, HP sauce/brown sauce, harissa, kochujang, hoisan sauce, kim chi, cholula hot sauce, tartar sauce, tahini, hummus, shichimi, ketchup, mustard, pasta sauce, Alfredo sauce, spaghetti sauce, icing, dessert toppings, or whipped cream, liquid egg, ice cream, animal food, any other food product or combination thereof. In some embodiments, the contact liquid CL can include a topical or oral drug a cream, an ointment, a lotion, an eye drop, an oral drug, an intravenous drug, an intramuscular drug, a suspension, a colloid, or any other form and can include any drug included within the FDA's database of approved drugs. In some embodiments, the contact liquid CL can include a health and beauty product, for example, toothpaste, mouth washes, mouth creams, denture fixing compounds, any other oral hygiene product, sun screens, anti-perspirants, anti-bacterial cleansers, lotions, shampoo, conditioner, moisturizers, face washes, hair-gels, medical fluids (e.g., anti-bacterial ointments or creams), any other health or beauty product, and or combination thereof. In some embodiments, the contact liquid CL can include any other non-Newtonian, thixotropic or highly viscous fluid, for example, laundry detergent, paint, oils, waxes, petroleum products, fabric softeners, industrial solutions, or any other contact liquid CL.

Interaction Between Various Phases in a Liquid-Impregnated Surface

A liquid-impregnated surface that is in contact with a contact liquid defines four distinct phases: an impregnating liquid, a surrounding gas (e.g., air), a contact liquid and a textured surface. The interactions between the different phases determine the morphology of the contact line (i.e., the contact line that defines the contact angle of a contact liquid droplet with the liquid-impregnated surface) because the contact line morphology substantially impacts the droplet pinning and therefore contact liquid mobility on the surface. There are various parameters which can play a role in defining the non-wetting performance of a liquid-impregnated surface. Key parameters include the relative contact angles of the impregnating liquid and the contact liquid, spreading coefficient, dimensions of the solid features, interfacial energies, and viscosities of the impregnating liquid and the contact liquid. Other factors include, for example, the roll off angle of contact liquid that affects how droplets are shed (whether they roll or slip), and what their shedding velocities are. Moreover, questions related to the longevity of the impregnated liquid film and its possible depletion, due to evaporation and entrainment with the droplets being shed, can have substantial bearing on the configuration of a liquid-impregnated surface, for example, the liquid-impregnated surface 100. Some of the key parameters and their impact on the liquid-impregnated surface are described below.

### 1) Contact Angle of the Impregnating Liquid

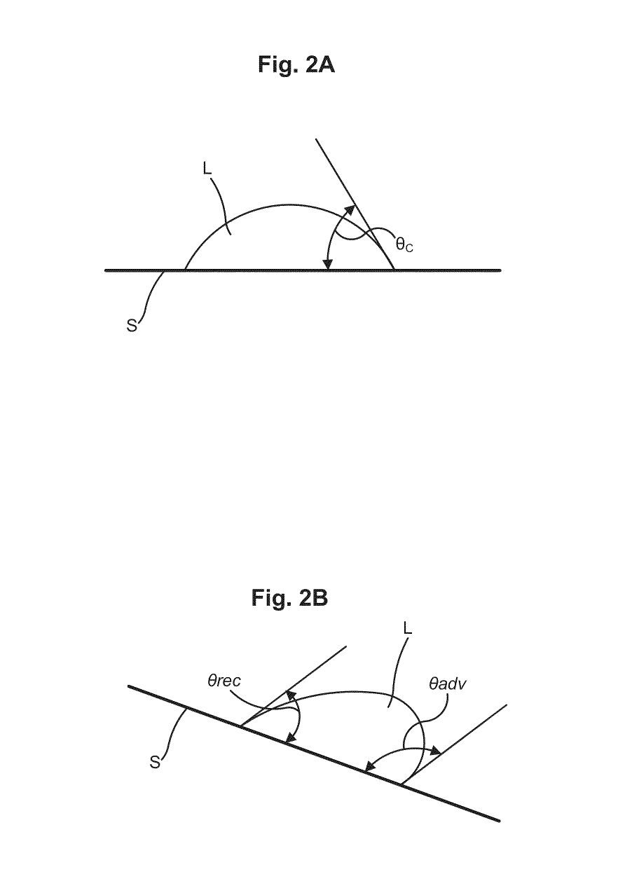

The contact angle, θₒₛ₍ₑ₎, is generally defined as the angle conventionally measured through goniometry, as the angle at which a liquid o, intersects with a surface, s, in the presence of an external phase ‘e’ (liquid or gas), at equilibrium. The contact angle can be a function of the hydrophobicity or hydrophilicity or surface energy of the liquid and the solid surface. The contact angle can also depend on the surface roughness. FIG. 2A shows the contact angle in air, θₒₛ₍ₐ₎ (also referred to as “the intrinsic angle” or “equilibrium contact angle” in air) of a droplet of a liquid ‘o’ (e.g., an impregnating liquid) disposed on a surface s (e.g., a smooth surface of the same material as surface 112,). If the surface is tilted such that the liquid droplet o starts displacing on the surface as shown in FIG. 2B, the liquid droplet o can now define an advancing (or maximal) contact angle θ_{os(a),adv} and a receding (or minimal) contact angle θ_{os(a),rec}. The contact angle hysteresis is then generally defined as the difference of the advancing and the receding contact angles.

A liquid-impregnated surface (e.g. the liquid-impregnated surface 100) can define two contact angles. The first is the contact angle θₒₛ₍ₐ₎ which is the contact angle of the impregnating liquid (subscript ‘o’) on a smooth surface of the same chemistry or material as the textured surface (subscript ‘s’) in the presence of air (subscript ‘a’). Said another way, this is the contact angle a droplet of impregnating liquid (e.g., the impregnating liquid 120) will form when disposed on a smooth solid surface of the same materials as 112 and surrounded by air. Complete submergence of the textured surface in air can happen if the contact angle θₒₛ₍ₐ₎=0°, such that the impregnating liquid is able to completely cover the plurality of solid features of surface 112, reducing φ to 0. Although complete submergence may be achieved temporarily by depositing excess impregnating liquid, eventually this excess will drain or flow away (e.g., under gravity or shear stress) and the liquid-air interface may contact the textured surface 112.

The second is the contact angle θ_{os(w)} which is defined by the impregnating liquid when surrounded by a contact liquid (subscript ‘w’) such as, for example, water, an aqueous liquid, or any other contact liquid described herein. In this scenario, the textured surface can remain submerged in the impregnating liquid if the contact angle θ_{os(w)} is also equal to zero. Information on whether both θₒₛ₍ₐ₎=0° and θ_{os(w)}=0° impacts the choice of an impregnating liquid, for example, the impregnating liquid 120, that can be used for a given droplet liquid and textured substrate material (e.g., the solid surface 110 that includes a plurality of solid features 112 disposed thereupon). If θₒₛ₍ₐ₎=0° and θ_{os(w)}=0°, then φ=0, resulting in zero contact between the contact liquid and the surface 112. Although this condition is desirable, it is not necessarily. Alternative, less constraining requirements are described below.

### 2) Spacing Between Solid Features of the Liquid-Impregnated Surface

The critical contact angle θ_{c}, also depends upon the interstitial spacing between the solid features included in the liquid-impregnated surface (e.g., the liquid-impregnated surface 100). The critical contact angle can be defined by

θ_{c}=cos⁻¹((1−θ)/(r−φ)),

where φ is the emerged area fraction, as described herein. The critical contact angle θ_{c} can dictate the stability of a liquid in an liquid-impregnated surface. The spacing between the solid features can be controlled such that the critical contact angle θ_{c} is increased above the receding contact angle θ_{rec,os(w)}, such that the surface 100 remains impregnated by the impregnating liquid 120. In this case, the contact liquid does not displace the impregnating liquid to impale the solid features, and easily sheds off the liquid-impregnated surface. If the interstitial spacing is too large, then the receding contact angle θ_{rec,os(w)} can be greater than the critical contact angle θ_{c}, such that the contact liquid can displace the impregnating liquid and impale the solid features, i.e. get pinned within the solid features. In the case that θ_{rec,os(a)}>0_{c}, the impregnating liquid cannot be made to impregnate the surface 112.

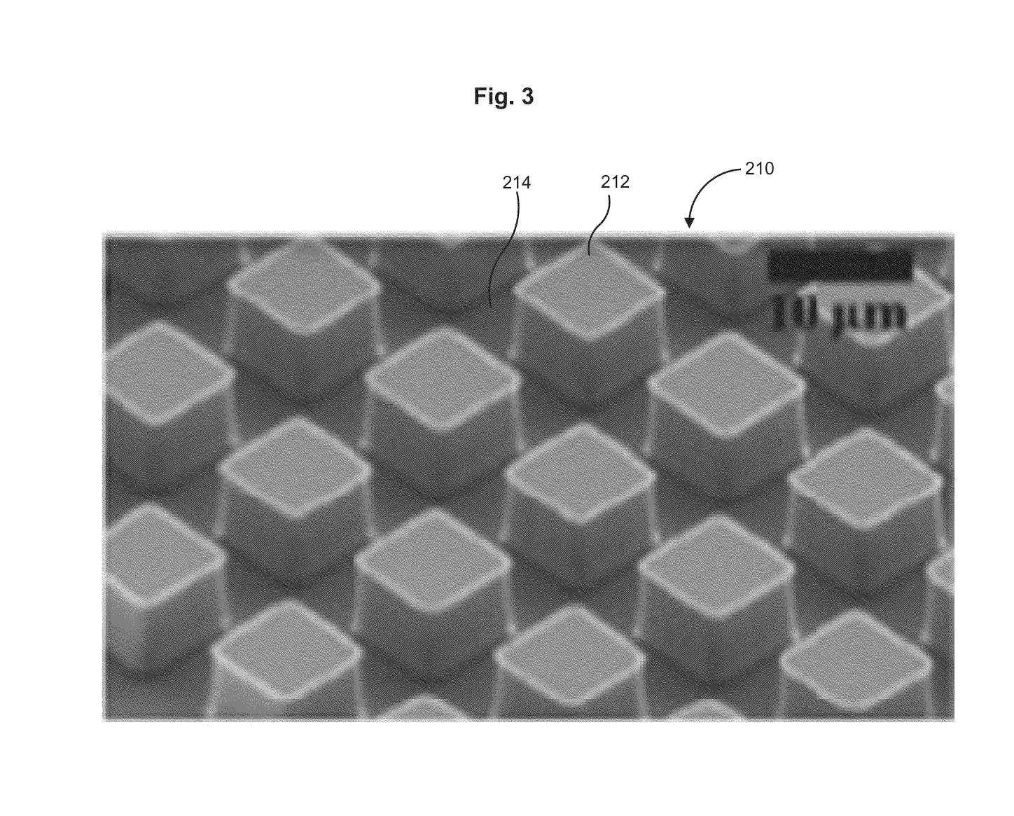

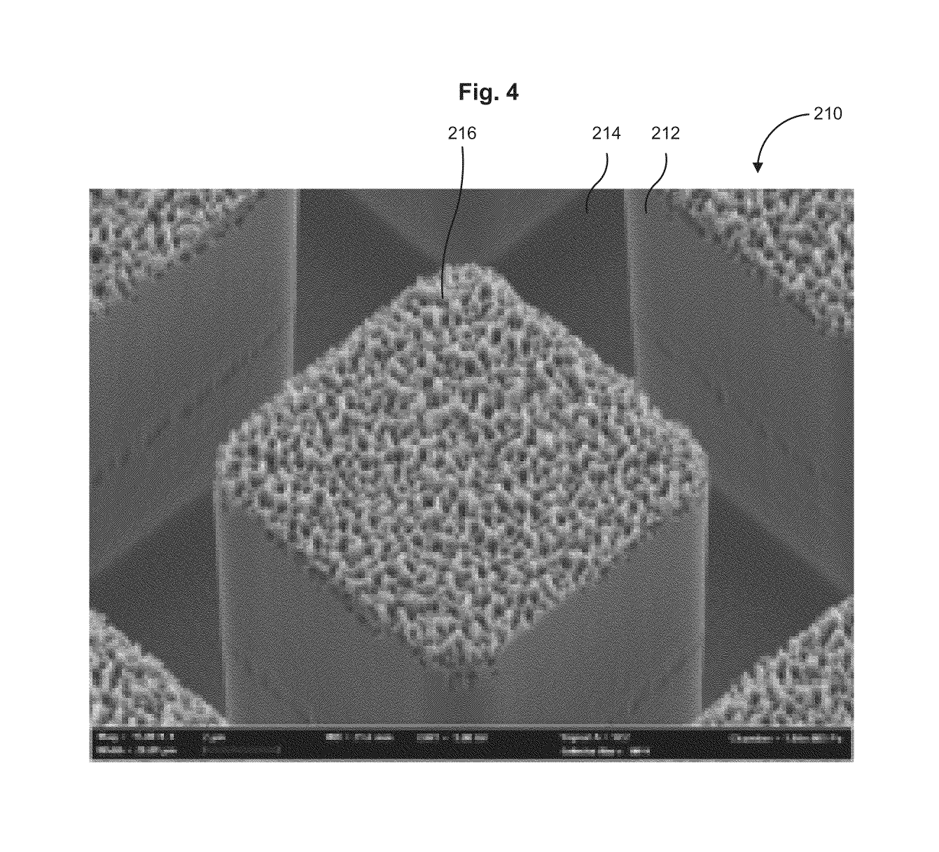

Referring now to FIGS. 3-6, a liquid-impregnated surface 200 includes a textured surface 210 and an impregnating liquid 220. The textured surface 210 includes square microposts 212 etched in silicon using standard photolithography process (FIG. 3). A photomask with square windows was used and the pattern was transferred to photoresist using UV light exposure. Next, reactive ion etching in inductively-coupled plasma was used to etch the exposed areas to form microposts 212, such that microposts 212 are separated by interstitial region 214. Each micropost 212 had a square geometry with width “a” of about 10 μm, height h of about 10 μm, and varying edge-to-edge spacing b of about 5, 10, 25, or 50 μm. A second level of roughness was produced on microposts 212, in some cases, by creating nanograss 216 (FIG. 4). For this purpose, Piranha-cleaned micropost 212 surfaces were etched in alternating flow of SF₆ and O₂ gases for 10 minutes in inductively-coupled plasma.

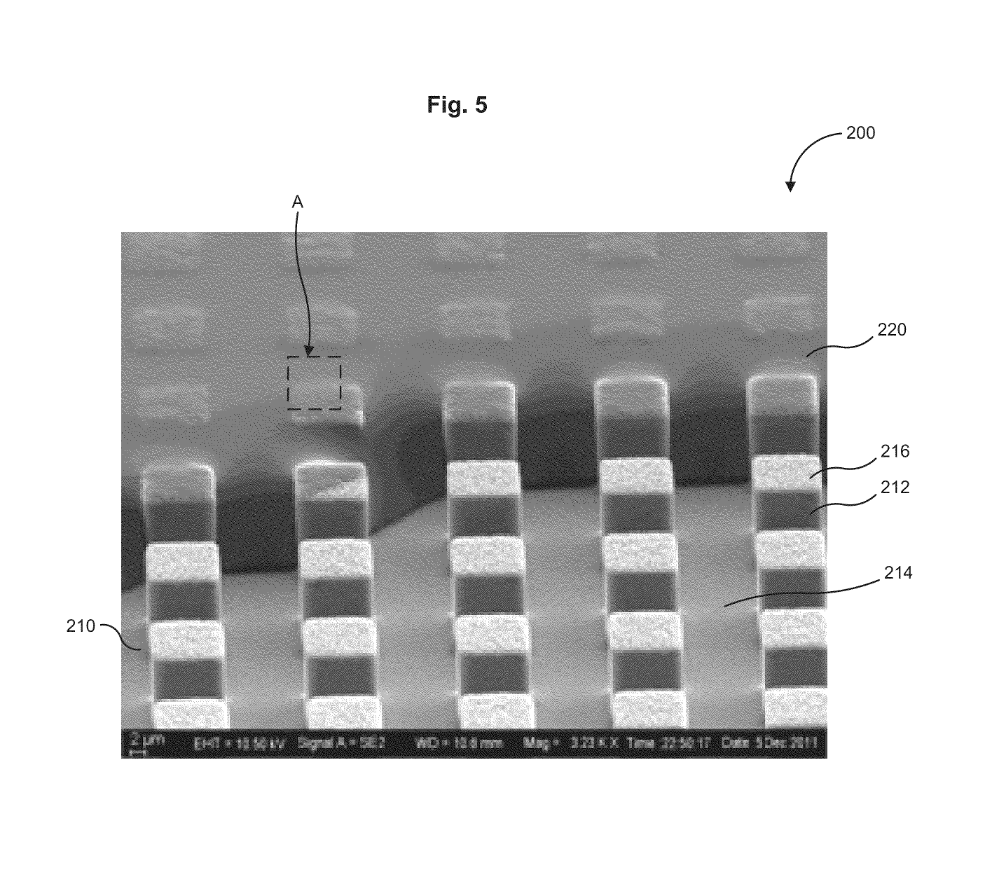

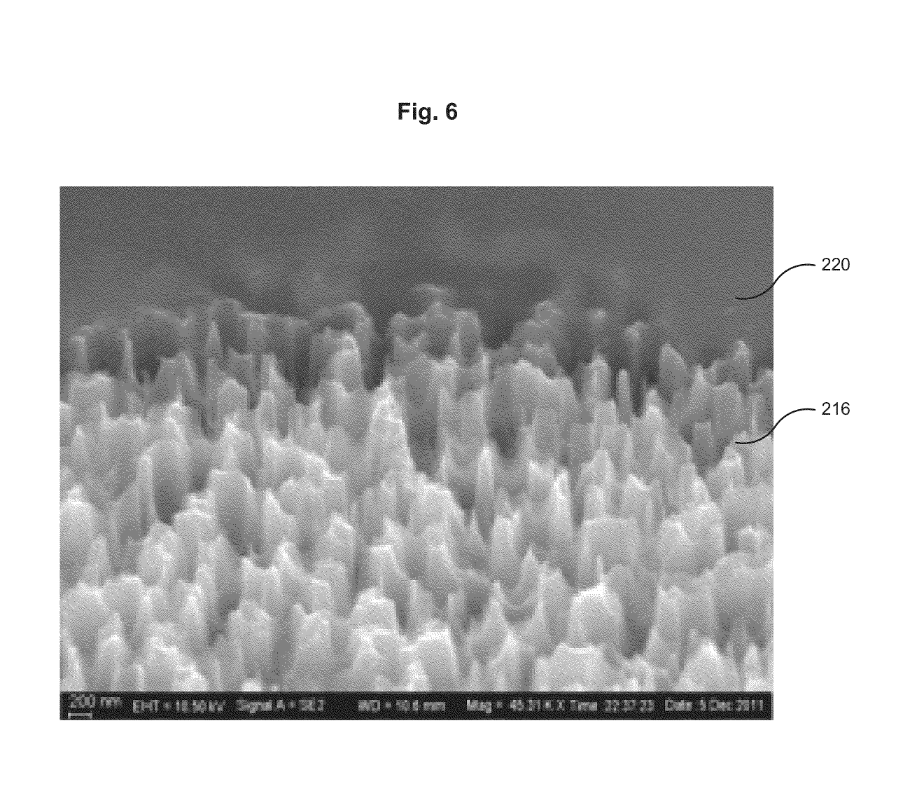

The samples were then cleaned in a Piranha solution and treated with a low-energy silane (octadecyltrichlorosilane (OTS)) by solution deposition. The textured surface 210 was impregnated with the impregnating liquid 220 (FIGS. 5 and 6), for example, BMIm (1-butyl-3-methylimidazolium bis(trifluoromethylsulfonyl)imide), silicone oil, or DI water, by slowly dipping the textured surface into a reservoir of the lubricant. The textured surface 210 was then withdrawn at speed S slow enough that capillary numbers Ca=μₒS/γₒₐ<10⁻⁵ to ensure that no excess fluid remained on the micropost 212 tops where μₒ is the dynamic viscosity and γₒₐ is the surface tension of the impregnating liquid 220. When the advancing angle θ_{adv,os(a)} is less than θ_{c} the impregnating liquid 220 film will not spontaneously spread into the textured surface 210, as can be seen for BMIm in FIG. 5. FIG. 6 shows an enlarged view of the region defined by the arrow A in FIG. 5. However, by withdrawing the textured surface 210 from a reservoir of BMIm, the impregnating film remains stable, since θ_{rec,os(a)}<θ_{c} for the microposts 212 with b=5 μm and 10 μm.

Table 1 shows various configuration of features formed on the textured surface 210. Table 2 includes intrinsic contact angles of impregnating liquids 220 on smooth surfaces of the same materials as the textured material 210. Note if the textured surface 210 is not coated with OTS, then θ_{os(w)}>θ_{c} for both impregnating liquids 220 and all post spacing b. Thus water droplets should displace the hydrophobic liquid 220 and get impaled by the microposts 212 leading to significant pinning, which was confirmed as such droplets did not roll-off of these textured surfaces.

TABLE 1

| Post spacing, b (μm) | R | φ | θ_{c} (°) |
|---|---|---|---|
| 5 | 2.8 | 0.44 | 76 |
| 7.5 | 2.3 | 0.33 | 70 |
| 10 | 2.0 | 0.25 | 65 |
| 25 | 1.3 | 0.08 | 42 |
| 50 | 1.1 | .093 | 26 |

### 3) Spreading Coefficient and “Cloaking”

In some embodiments, an impregnating liquid can “cloak” a droplet of a contact liquid. Cloaking occurs when the impregnating liquid spreads over the droplet of the contact liquid. In some embodiments, cloaking can cause the contact liquid to impale the impregnating liquid and therefore negatively impact the non-wetting characteristics of a liquid-impregnated surface (e.g., the liquid-impregnated surface 100). Furthermore, cloaking can also cause the impregnating liquid to get entrained with the contact liquid. This can lead to a loss of the impregnating liquid as the contact liquid is displaced from the liquid-impregnated surface. The degree of cloaking of the contact liquid with the impregnating liquid depends on the spreading coefficient S_{ow(a)} of the impregnating liquid on the contact liquid in air. The spreading coefficient S_{ow(a)} can be determined from the relative surface tension at the interface of each of the impregnating liquid, contact liquid, and air by the equation S_{ow(a)}=γ_{wa}−γ_{wo}−γₒₐ. Here γ_{wa} is the interfacial surface tension between the contact liquid and air, γ_{wo} is the interfacial surface tension between the contact liquid and the impregnating liquid, and γₒₐ is the interfacial surface tension between the impregnating liquid and air. If S_{aw(a)}>0, then cloaking will occurs, and if S_{ow(a)}<0 then only partial cloaking or substantially no cloaking will occur. This knowledge can be used to select an impregnating liquid that provides an interfacial surface tension γ_{wo} between the contact liquid and the impregnating liquid such that S_{ow(a)}<0, and cloaking can be reduced or substantially eliminated.

In some embodiments, cloaking can be desirable and can be used as a means for preventing environmental contamination, like a time capsule preserving the contents of the cloaked material. Cloaking can result in encasing of the material thereby cutting its access from the environment. This can be used for transporting materials (e.g., bioassays) across a length in a way that the material is not contaminated by the environment. In some embodiments, cloaking can be exploited to prevent corrosion, fouling, etc. In some embodiments, cloaking can be used for preventing vapor-liquid transformation (e.g., water vapor, metallic vapor, etc.). In some embodiments, cloaking can be used for inhibiting liquid-solid formation (e.g., ice, metal, etc.). In some embodiments, cloaking can be used to make reservoirs for carrying the materials, such that independent cloaked materials can be controlled and directed by external means (like electric or magnetic fields).

In some embodiments, the amount of cloaking can be controlled by various properties of the impregnating liquid such as, for example, viscosity and/or surface tension of the impregnating liquid. Additionally or alternatively, the de-wetting of the cloaked material can also be controlled to release the material, for example a system in which a product is disposed on the liquid-impregnated surface at one end, and upon reaching the other end is exposed to an environment that causes the product to uncloak.

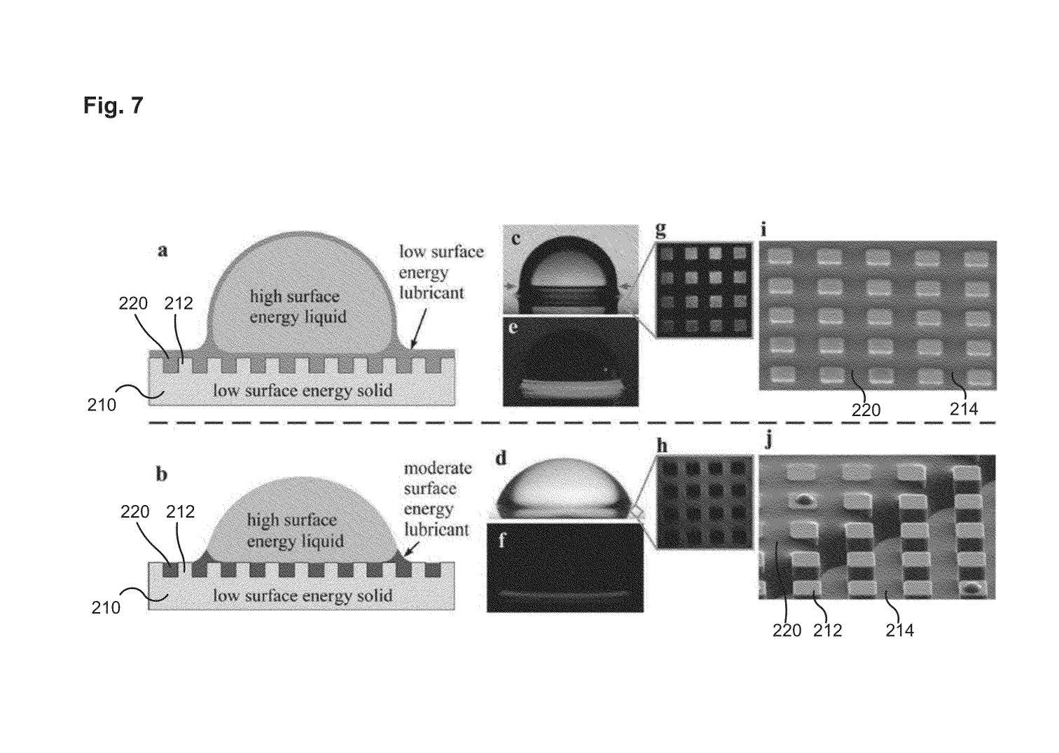

Referring now to FIGS. 7a and 7b, the surface 210 which includes the solid features 212 disposed thereon was impregnated with two different impregnating liquids 220; silicone oil, for which S_{ow(a)}≈6 mN/m and an ionic liquid (1-butyl-3-methylimidazolium bis(trifluoromethylsulfonyl)imide-BMIm) for which S_{ow(a)}≈5 mN/m. Ionic liquids have extremely low vapor pressures (˜10⁻¹² mmHg), and therefore they mitigate the concern of the impregnating liquid loss through evaporation. Goniometric measurements of the advancing and receding contact angles of these liquids in the presence of air and water as well as their interfacial tensions were performed and are presented in Table 2 and Table 3.

TABLE 2

| Impregnating | | | | | |
|---|---|---|---|---|---|
| Liquid | Surface | θ_{adv, os(a)} (°) | θ_{rec, os(a)} (°) | θ_{adv, os(w)}(°) | θ_{rec, os(w)} (°) |
| Silicone oil | OTS-treated silicon | 0 | 0 | 20 ± 5 | 0 |
| BMIm | OTS treated silicon | 67.8 ± 0.3 | 60.8 ± 1.0 | 61.3 ± 3.6 | 12.5 ± 4.5 |
| DI water | OTS-treated silicon | 112.5 ± 0.6 | 95.8 ± 0.5 | NA | NA |
| Silicone oil | Silicon | 0 | 0 | 153.8 ± 1.0 | 122 ± 0.8 |
| BMIm | Silicon | 23.5 ± 1.8 | 9.8 ± 0.9 | 143.4 ± 1.8 | 133.1 ± 0.9 |
| DI water | Silicon | 20 ± 5° | 0 | NA | NA |

Table 3 shows surface and interfacial tension measurements and resulting spreading coefficients S_{ow(a)}=γ_{wa}−γ_{ow}−γₒₐ, of 9.34, 96.4, and 970 cP Dow Corning PMX 200 Silicone oils on water in air. Values of γ_{ow} were provided by Dow Corning.

TABLE 3

| Impregnating | | | | |
|---|---|---|---|---|
| Liquid | γ_{ow}(mN/m) | γₒₐ (mN/m) | γ_{wa} (mN/m) | S_{ow(a)} (mN/m) |
| Silicone oil | 46.7 | 20.1 | 72.2 | 5.4 |
| (9.34 cP, | | | | |
| 96.4 cP) | | | | |
| Silicone oil | 45.1 | 21.2 | 72.2 | 5.9 |
| (970 cP) | | | | |

As shown in FIG. 7b, in the case of BMIm there are three distinct 3-phase contact lines at the perimeter of the drop that confine the wetting ridge: the oil-water-air contact line, the oil-solid-air contact line outside the drop, and the oil-solid-water contact line underneath the drop. These contact lines exist because θₒₛ₍ₐ₎>0, θ_{os(w)}>0, and S_{ow(a)}<0. In contrast, in the case of silicone oil (FIG. 7a), none of these contact lines exist because θₒₛ₍ₐ₎=0, θ_{os(w)}=0, and S_{ow(a)}>0.

FIG. 7c shows an 8 μl water droplet placed on the silicone oil impregnated textured surface 210. The droplet forms a large apparent contact angle (˜100 degrees) but very close to the solid surface (arrows in FIG. 7c), its profile changes from convex to concave. When a fluorescent dye was added to the silicone oil and imaged under UV light, the point of inflection corresponded to the height to which an annular ridge of silicone oil was pulled up in order to satisfy a vertical force balance of the interfacial tensions at the inflection point (FIG. 7e). Although, the oil should spread over the entire droplet (FIG. 7c), the cloaking film was too thin to be captured in these images. The “wetting ridge” was also observed in the case of ionic liquid (FIG. 7d, FIG. 7f). Such wetting ridges are reminiscent of those observed around droplets on soft substrates.

As described herein, the textured surface 210 can be completely submerged in the impregnating liquid 220 if θₒₛ₍ₐ₎=0°. This condition was found to be true for silicone oil, implying that the tops of the microposts 212 should be covered by a stable thin oil film. This film was observed experimentally using laser confocal fluorescence microscopy (LCFM); the micropost 212 tops appear bright due to the presence of a fluorescent dye that was dissolved in the oil (FIG. 7g). Environmental SEM images of the surface (FIG. 7i) show the oil-filled texture and confirm that this film is less than a few microns thick, consistent with prior estimates of completely-wetting films. On the other hand, BMIm has a non-zero contact angle on a smooth OTS-coated silicon surface (θₒₛ₍ₐ₎=65±5°) indicating that with this impregnating liquid the post tops should remain dry. This was confirmed by LCFM images (FIG. 7h) which showed that the post tops appear dark as there is no dye present to fluoresce. Since BMIm is conductive and has an extremely low vapor pressure, it could be imaged in a SEM. As shown in FIG. 7j, discrete droplets resting on micropost tops are seen, confirming that a thin film was not stable on the post tops in this case.

Stable Configuration of Contact Liquid Droplets on Liquid-Impregnated Surfaces

The relationships between the contact angles and the spreading coefficient of the impregnating liquid can be used to develop a thermodynamic framework to determine various states of the liquid-impregnated surface. The thermodynamic framework which is based on the interfacial energies of the surface, impregnating liquid, contact liquid, and ambient air can be used to ascertain a combination of a textured surface and impregnating liquid that will provide most favorable non-wetting properties for any particular contact liquid.

As described herein, a liquid-impregnated surface that includes an impregnating liquid (e.g., oil) disposed on a textured surface in the presence of air (i.e., no contact liquid) can have three possible states. These include a first state A1 in which the solid features of the surface are not impregnated with impregnating liquid (i.e., are dry), a second state A2 in which the solid features of the surface are impregnated with impregnating liquid but have emergent features, and a third state A3 in which the solid features are completely impregnated with the impregnating liquid (i.e., encapsulated). The same liquid-impregnated surface can have three separate states when a contact liquid (e.g., water) is in contact with the liquid-impregnated surface. These include a first state W1 in which the textured surface is impaled with the contact liquid, a second state W2 in which the solid features of the surface are impregnated with impregnating liquid but have emergent features, and a third state W3 in which the solid features are completely impregnated with the impregnating liquid (i.e., encapsulated). The stable state will be the one that has the lowest interfacial energy E. For example, if state W3 has the lowest interfacial energy E_{W3}, this will be the most stable state. In this state the impregnating liquid will substantially encapsulate the solid features of the textured surface in the presence of the contact liquid and thereby, provide optimum non-wetting properties. Thus, knowledge of the interfacial energy can be used to select the best combination of the textured surface and the impregnating liquid for a given contact liquid.

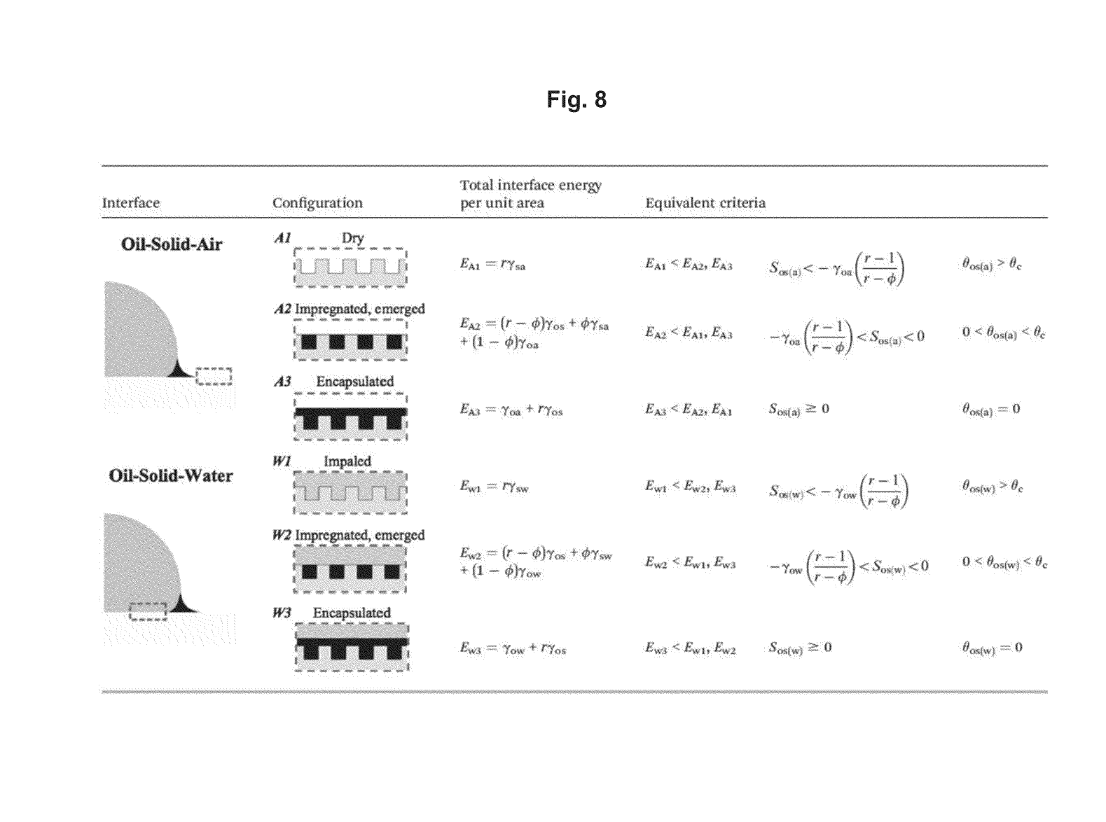

FIG. 8 shows various states of liquid-impregnated surface that includes oil as the impregnating liquid and water as the contact liquid. First, the states of the liquid-impregnated surface in air (i.e., without the contact liquid) are discussed. A textured surface, for example, textured surface 210, is slowly withdrawn from a reservoir of oil. The resulting surface could be in any of states A1, A2, and A3 depending on which has the lowest energy. For example, state A2 would be stable if it has the lowest total interface energy, i.e. E_{A2}<E_{A1}, E_{A3}. From FIG. 8, this results in:

E_{A2}<E_{A1} [symbol] (γₛₐ−γₐₛ)/γₒₐ>(1−φ)/(r−φ) (1)

E_{A2}<E_{A3} [symbol] γₛₐ−γₒₛ−γₒₐ<0 (2)

where φ is the emergent area fraction, and r is the ratio of total surface area to the projected area of the solid. In the case of square posts with width a, edge-to-edge spacing b, and height h, φ=a²/(a+b)² and r=1+4ah/(a+b)². Applying Young's equation, cos(θₒₛ₍ₐ₎)=(γₛₐ−γₒₛ)/γₒₐ, Eq. (1) reduces to the hemi-wicking criterion for the propagation of a oil through a textured surface: cos(θₒₛ₍ₐ₎)>(1−φ)/(r−φ)=cos(θ_{c}). This requirement can be conveniently expressed as θₒₛ₍ₐ₎<0. In Eq. (2), γₛₐ−γₒₛ−ₒₐ, is simply the spreading coefficient Sₒₛ₍ₐ₎ of oil on the textured surface in the presence of air. This can be reorganized as (γₛₐ−γₒₛ)/γₒₐ<1, and applying Young's equation again, Eq. (2) can be written as θₒₛ₍ₐ₎>0. Expressing Eq. (1) in terms of the spreading coefficient Sₒₛ₍ₐ₎, yields: −γₒₐ(r−1)/(r−φ)<Sₒₛ₍ₐ₎. The above simplifications then lead to the following equivalent criteria for the surface to be in state A2:

E_{A2}<E_{A1},E_{A3} [symbol] θ_{c}>θₒₛ₍ₐ₎>0 [symbol] −γₒₐ(r−1)/(r−φ)<Sₒₛ₍ₐ₎<0 (3)

Similarly, state A3 would be stable if E_{A3}<E_{A2}, E_{A1}. From FIG. 8, this gives:

E_{A3}<E_{A2} [symbol] θₒₛ₍ₐ₎=0 [symbol] γₛₐ−γₒₛ−γₒₐ≡Sₒₛ₍ₐ₎≧0 (4)

E_{A3}<E_{A1} [symbol] θₒₛ₍ₐ₎<cos⁻¹(1/r) [symbol] Sₒₛ₍ₐ₎>−γₒₐ(1−1/r) (5)

Note that Eq. (5) is automatically satisfied by Eq. (4), thus the criterion for state A3 to be stable (i.e. encapsulation) is given by Eq. (4). Following a similar procedure, the condition for state A1 to be stable can be derived as:

E_{A1}<E_{A2},E_{A3} [symbol] θₒₛ₍ₐ₎>θ_{c} [symbol] Sₒₛ₍ₐ₎<−γₒₐ(r−1)/(r−φ) (6)

The rightmost expression of Eq. (4) can be rewritten as (γₛₐ−γₒₛ)/γₒₐ>1. Young's equation would suggest that if θₒₛ₍ₐ₎=0 degrees, then (γₛₐ−γₒₛ)γₒₐ=1 (i.e. Sₒₛ₍ₐ₎=0). However, θₒₛ₍ₐ₎=0 degrees is true also for the case that (γₛₐ−γₒₛ)/γₒₐ>1 (i.e. S_{os(a)>}0). Young's equation predicts the contact angle based on balancing the surface tension forces on a contact line, such that the equality only exists for a contact line at static equilibrium. For a spreading film (Sₒₛ₍ₐ₎>0) a static contact line doesn't exist, hence precluding the applicability of Young's equation.

Referring now to the states of the liquid-impregnated surface in the presence of water as the contact liquid, the interface beneath the droplet will attain one of the three different states—W1, W2, or W3 (FIG. 8) depending on which has the lowest energy, as described herein. Applying the same method to determine the stable configurations of the interface beneath the droplet as described herein, and using the total interface energies provided in FIG. 8, the stability requirements take a form similar to equations (3), (4), and (6), with γₒₐ, γₛₐ, θₒₛ₍ₐ₎, Sₒₛ₍ₐ₎, replaced with γ_{ow}, γ_{sw}, θ_{os(w)}, S_{os(w)} respectively. The critical contact angle θ_{c} is not affected by the surrounding environment as it is only a function of the texture parameters, φ and r. Thus, the texture will remain impregnated with oil beneath the droplet with emergent post tops (i.e. state W2) when:

E_{W2}<E_{W1},E_{W3} [symbol] θ_{c}>θ_{os(w)}>0 [symbol] −γ_{ow}(r−1)/(r−φ)<S_{os(w)}<0 (7)

State W3 will be stable (i.e. the oil will encapsulate the texture) when:

E_{W3}<E_{W1},E_{W2} [symbol] θ_{os(w)}≡0 [symbol] γ_{sw}−γₒₛ−_{ow}≡S_{os(w)}≧0. (8)

and the droplet will displace the oil and be impaled by the textures (state W1) when:

E_{W1}<E_{W2},E_{W3} [symbol] θ_{os(w)}>θ_{c} [symbol] S_{os(w)}<−γow(r−1)/(r−φ) (9)

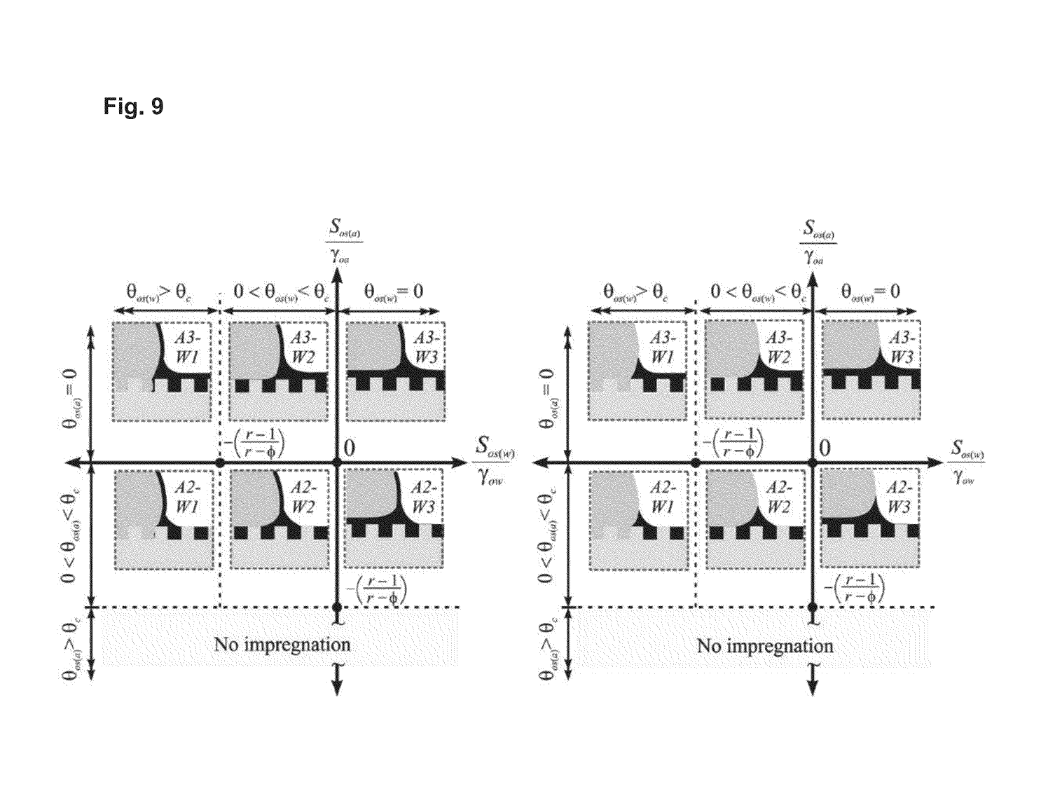

This thermodynamic framework can be combined with the cloaking criterion described herein to obtain an overall framework which can be used to predict the performance of a liquid-impregnated surface in the presence of any particular contact liquid. FIG. 9 shows the various thermodynamic states of a textured surface impregnated with an impregnating liquid (oil) and that includes a droplet of a contact liquid (water) disposed thereon. The states of the liquid-impregnated surface are predicted for a first configuration in which the spreading coefficient S_{ow(a)}>0 (i.e., the impregnating liquid cloaks the droplet of the contact liquid), and a second configuration in which the spreading coefficient S_{ow(a)}<0 (i.e., no cloaking occurs). The cloaking criterion is represented by the upper two schematic drawings shown in FIG. 9. For each of these configurations, six different states are possible depending on how the oil interacts with the surface texture in the presence of air (vertical axis in FIG. 9) and water (horizontal axis in FIG. 9). The vertical and horizontal axes are the normalized spreading coefficients Sₒₛ₍ₐ₎/γₒₐ and S_{os(w)}/γ_{ow} respectively. Considering first the vertical axis of FIG. 9, when Sₒₛ₍ₐ₎/γₒₐ<−(r−1)/(r−φ) (i.e., when Eq. (6) holds), oil does not even impregnate the texture. As Sₒₛ₍ₐ₎/γₒₐ increases above this critical value, impregnation becomes feasible but the post tops are still left emerged. Once Sₒₛ₍ₐ₎/γₒₐ>0, the post tops are also submerged in the oil leading to complete encapsulation of the texture. Similarly, on the x-axis of FIG. 9 moving from left to right, as S_{os(w)}/γ_{ow} increases, the droplet transitions from an impaled state to an impregnated state to a fully-encapsulated state.

FIG. 9 shows that there can be up to three different contact lines, two of which can get pinned on the texture. The degree of pinning determines the roll-off angle α* which is the angle of inclination at which a droplet of a contact liquid placed on the textured surface begins to move. Droplets that completely displace the oil (states A3-W1, A2-W1 in FIG. 8) are not expected to roll off the surface. These states are achieved when θ_{os(w)}>0, as is the case for both BMI-Im and silicone oil impregnated surfaces when the silicon substrates are not treated with OTS (see Table 1). As expected, droplets did not roll off of these surfaces. Droplets in states with emergent post tops (A3-W2, A2-W2, A2-W3) are expected to have reduced mobility that is strongly texture dependent, whereas those in states with encapsulated posts outside and beneath the droplet (the A3-W3 states in FIG. 8) are expected to exhibit no pinning and consequently infinitesimally small roll-off angles α*.

Solid Feature Spacing, Hierarchical Solid Features, and Roll off Angle

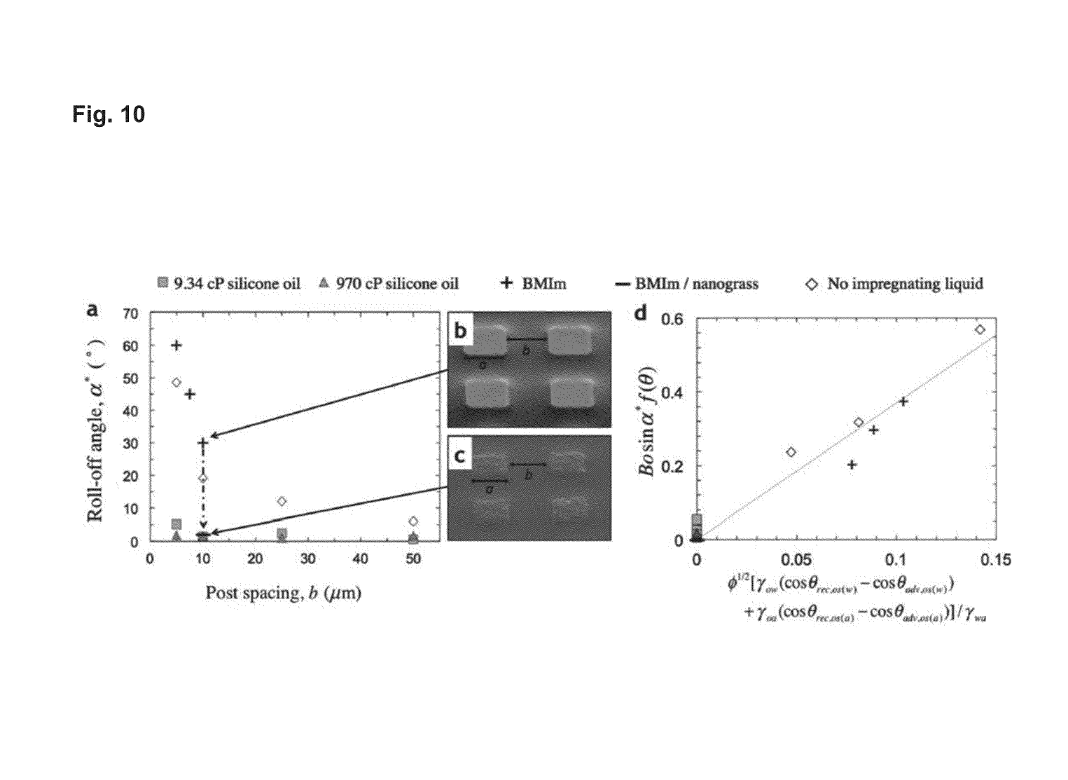

In some embodiments, solid features disposed on a surface can be configured to include hierarchical features, as described herein. Such hierarchical features can enable complete impregnation and encapsulation of the solid features with an impregnating liquid that would otherwise not completely encapsulate the solid features if the hierarchical features are absent. FIG. 10a-d shows measurements on roll-off angles α* of 5 μl water droplets on silicone oil and BMIm impregnated textured surfaces with varying post spacing b. For comparison, the same textured surfaces without an impregnating liquid (no impregnating liquid, which is the conventional super impregnating case) were also evaluated. The silicone oil encapsulated textured surfaces have extremely low roll-off angles α* regardless of the post spacing b and oil viscosity, showing that contact line pinning was negligible, as predicted for a liquid droplet in an A3-W3 state with no contact lines on the textured substrate. On the other hand, BMIm impregnated textures showed much higher roll-off angles α*, which increased as the spacing decreased—a trend that is similar to Cassie droplets on super impregnating surfaces. This observation shows that pinning was significant in this case, and occurs on the emergent post tops (FIG. 10b). Pinning was significantly reduced by adding a second smaller length scale texture (i.e. nanograss on the posts), so that BMIm impregnated the texture even on the post tops, thereby substantially reducing the emergent area fraction φ. The roll-off angle α* decreased from over 30 degrees to only about 2 degrees. Note that the reduction in the emergent area fraction φ is not due to the absolute size of the texture features; since the oil-water and oil-air interfaces intersect surface features at contact angles θ_{os(w)} and θ_{ow(a)}, and φ depends on these contact angles and feature geometry.

The effect of texture on the roll-off angle α* can be modeled by balancing gravitational forces with pinning forces. A force balance of a water droplet on a smooth solid surface at incipient motion gives ρ_{w}Ωg sin α*≈2R_{b}γ_{wa}(cos θ_{rec,ws(a)}=cos θ_{adv,ws(a)}), where ρ_{w} is the density of the contact liquid droplet of volume Ω, g is the gravitational acceleration, R_{b} is the droplet base radius, and θ_{adv,ws(a)} and θ_{rec,ws(a)} are the advancing and receding contact angles of contact liquid droplet in air on the smooth solid surface. Pinning results from contact angle hysteresis of up to two contact lines: an oil-air-solid contact line with a pinning force per unit length given by γₒₐ(cos θ_{rec,os(a)}−cos θ_{adv,os(a)}), and an oil-water-solid contact line with a pinning force per unit length given by γ_{ow}(cos θ_{rec,os(w)}−cos θ_{adv,os(w)}). The length of the contact line over which pinning occurs is expected to scale as R_{b}φ^{1/2} where φ^{1/2} is the fraction of the droplet perimeter (˜R_{b}) making contact with the emergent features of the textured substrate. Thus a force balance tangential to the surface gives:

ρ_{w}Ωg sin α*˜r_{B}φ^{1/2}[γ_{ow}(cos θ_{rec,os(w)}−cos θ_{adv,os(w)})+γₒₐ(cos θ_{rec,os(a)}−cos θ_{adv,os(a)})] (10)

Dividing Eq. (10) by R_{b}γ_{wa} we obtain a non-dimensional expression:

Bo sin α*f(θ)˜φ^{1/2}[(γ_{ow}(cos θ_{rec,os(w)}−cos θ_{adv,os(w)})+γₒₐ(cos θ_{rec,os(a)}−cos θ_{adv,os(a)})]/γ_{wa} (11)

where f(θ)=Ω^{1/3}/R_{b}=[(π/3)(2+cos θ)(1−cos θ)²/sin³ θ)]^{1/3} by assuming the droplet to be a spherical cap making an apparent contact angle θ with the surface. Bo=Ω^{2/3}ρ_{w}g/γ_{wa} is the Bond number, which compares the relative magnitude of gravitational forces to surface tension forces. Values for θ_{rec,os(w)}, θ_{adv,os(w)}, θ_{rec,os(a)}, θ_{adv,os(a)}, γ_{ow}, γₒₐ, and γ_{wa} are provided in Tables 2 and 3. FIG. 10d shows that the measured data is in reasonable agreement with the scaling of Eq. (11). The data for the silicone oil encapsulated surface and for the BMIm impregnated, nanograss-covered posts lie close to the origin as both φ and α* are very small in these cases.

Dynamics of Droplet Shedding—Rolling Angle and Rolling Velocity

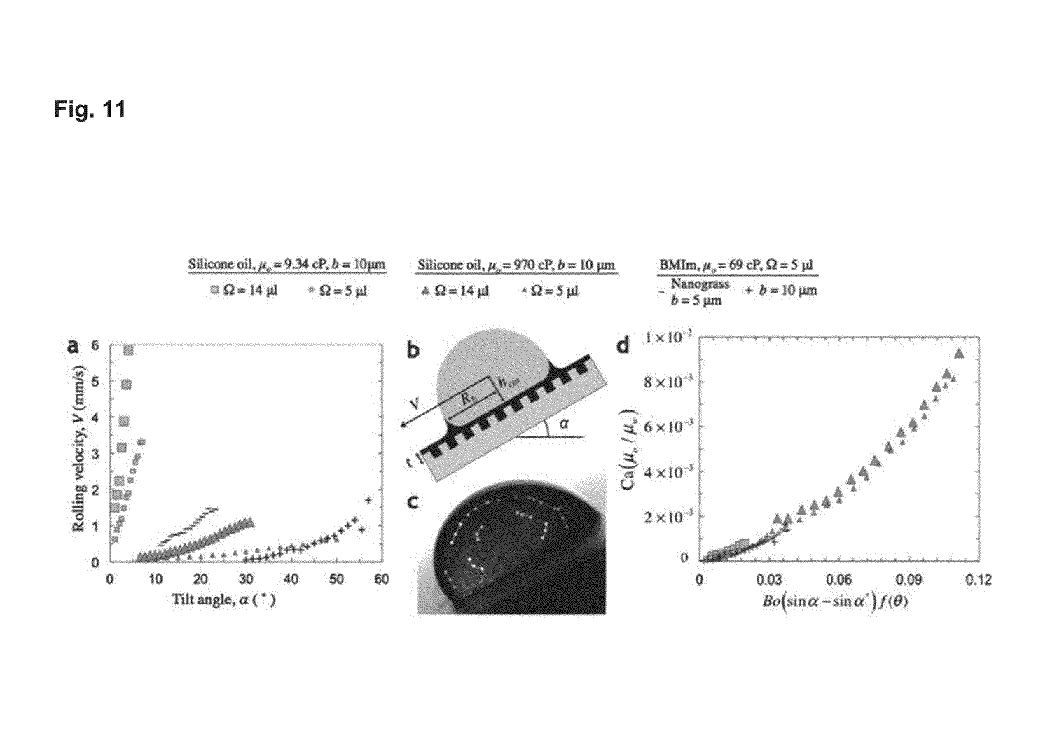

The speed or velocity at which a contact liquid having a volume Ω disposed on a liquid-impregnated surface, rolls of the liquid-impregnated surface depends on the viscosity of the impregnating liquid and the pinning of the contact line of a droplet of the contact liquid on the liquid-impregnated surface. Once gravitational forces acting on the contact liquid droplet overcome the pinning forces, the velocity attained by the droplet determines how quickly it can be shed, which reflects the non-wetting performance of the surface. The steady-state shedding velocity V of water droplets on a liquid-impregnated surface which was substantially similar to the liquid-impregnated surface 200, was measured using a high-speed camera while systematically varying the impregnating liquid dynamic viscosity μₒ, post spacing b, textured surface tilt angle α, and droplet volume, Ω. These measurements are shown in FIG. 11a where V is plotted as a function of a for different μₒ, b, and Ω; the velocity V, increases with α and Ω a; both increase the gravitational force acting on the droplet. As shown, V decreases with μₒ and as both increase the resistance to droplet motion.

To explain these trends, it is first determined whether the water droplet is rolling or sliding. Consider the oil-water interface beneath the droplet as shown in FIG. 11b. The shear stress at this interface, on the water side, scales as τ_{w}˜μ_{w}(V−Vᵢ)/h_{cm} and on the oil side scales as τₒ˜μₒVᵢ/t, where Vᵢ is the velocity of the oil-water interface and h_{cm} is the height of the centre of mass of the droplet above the solid surface, and t is the thickness of the oil film. Since τ_{w} must be equal to τₒ at the oil-water interface, μ_{w}(V−Vᵢ)/h_{cm}˜μₒVᵢ/t. Rearranging this gives:

$${V}_{i} / V ∼ {( 1 + \frac{{μ}_{o}}{{μ}_{w}} \frac{{h}_{cm}}{t} )}^{- 1} \qquad ( 12 )$$

Since (μₒ/μ_{w}(h_{cm}/t)>>1 as described herein, Vᵢ/V<<1, i.e. the oil-water interface moves at a negligibly small velocity relative to that of the water droplet's centre of mass. This suggests that the water droplets being shed on the textured surface, for example, textured surface 210, are rolling. This was further confirmed by adding ground coffee particles to the water droplet and tracking their motion relative to the droplet with a high-speed camera as the water droplet moved across the surface. Particle trajectories, shown in FIG. 11c, clearly show that the water droplets roll across the liquid-impregnated surface as they are shed (μₒ=96.4 cP).

To determine the magnitude of V, the rate of change of gravitational potential energy is balanced as the droplet rolls down the incline with the total rate of energy dissipation due to contact line pinning and viscous effects. The resulting energy balance gives:

$$V ( {F}_{g} - {F}_{p} ) ∼ {μ}_{w} {\int }_{{Ω}_{drop}} {( ∇ \overline{u} )}_{drop}^{2} d Ω + {μ}_{o} {\int }_{{Ω}_{film}} {( ∇ \overline{u} )}_{film}^{2} d Ω + {μ}_{o} {\int }_{{Ω}_{ridge}} {( ∇ \overline{u} )}_{ridge}^{2} d Ω \qquad ( 13 )$$

where F_{g} and Fₚ represent the net gravitational and pinning forces acting on the water droplet, the Ω terms are the volume over which viscous dissipation occurs, and the □ū terms are the corresponding velocity gradients. The form of Eq. (13) is similar to that for viscous contact liquid droplets rolling on completely non-wetting surfaces though additional terms are present due to the presence of the impregnated oil. The three terms on the right side of Eq. (13) represent the rate of viscous dissipation within the droplet (I), in the oil film beneath the droplet (II), and in the wetting ridge near the three-phase contact line (III).

The rate of viscous dissipation (i.e., the energy lost by the rolling droplet of the contact liquid due to its viscosity) within the water droplet (I) is primarily confined to the volume beneath its centre of mass and can be approximated as I˜u_{w}(V/h_{cm})²R_{b}²h_{cm}, where R_{b} is the base radius of the droplet. Applying geometrical relations for a spherical cap, R_{b}/h_{cm}=g(θ)=4/3 (sin θ)(2+cos θ)/(1+cos θ)² results in:

I˜μ_{w}V²R_{b}g(θ)

The rate of viscous dissipation within the film (II) can be approximated as II˜μₒ(Vᵢ/t)²R_{b}²t. Since (μ_{w}/μₒ)(t/h_{cm})<<1, from Eq. (12) □ū_{film}˜Vᵢ/t˜(u_{w}/μₒ)(V/h_{cm}). Using h_{cm}=R_{b}/g(θ) can be rewritten, such that:

$$II ∼ \frac{{μ}_{w}^{2}}{{μ}_{o}} {{V}^{2} [ g ( θ ) ]}^{2} t$$

Finally, the rate of viscous dissipation in the wetting ridge (III) can be approximated as III˜μₒ(V/h_{ridge})²R_{b}h²_{ridge} since fluid velocities within the wetting ridge must scale as the velocity of the centre of mass and vanish at the solid surface, giving velocity gradients that scale as □ū˜V/h_{ridge}, where h_{ridge} is the height of the wetting ridge. Thus,

III˜μₒV²R_{b}.

Noting that F_{g}=ρ_{w}g sin α and Fₚ=ρ_{w}Ωg sin α* and dividing both sides of Eq. (13) by R_{b}Vγ_{wa} yields

$$Bo ( sin α - sin {α}^{*} ) f ( θ ) ∼ Ca \{ g ( θ ) + {[ g ( θ ) ]}^{2} \frac{{μ}_{w}}{{μ}_{o}} \frac{t}{{R}_{b}} + \frac{{μ}_{o}}{{μ}_{w}} \} \qquad ( 14 )$$

Where Ca=μ_{w}V/γ_{wa}, is the capillary number, Bo=Ω^{2/3}ρ_{w}g/γ_{wa} is the Bond number, and f(θ)=Q^{1/3}/R_{b} (described before herein). Since (μ_{w}/μₒ)(t/R_{b})<<1, and μₒ/μ_{w}>>g(θ) in our experiments, Eq. (14) can be simplified to:

$$Bo ( sin α - sin {α}^{*} ) f ( θ ) ∼ Ca \frac{{μ}_{o}}{{μ}_{w}} \qquad ( 15 )$$

The datasets shown in FIG. 11a were organized according to Eq. (15) and were found to collapse onto a single curve (FIG. 11d), demonstrating that the above scaling model captures the essential physics of the phenomenon: the gravitational potential energy of the rolling water droplet is primarily consumed in viscous dissipation in the wetting ridge around the base of the rolling droplet. Similar conclusions apply to solid spheres rolling on thin films of viscous oil. Furthermore, Eq. (14) and Eq. (15) apply for cloaked and uncloaked droplets, because inertial and gravitational forces in the cloaking films are very small. Consequently, the velocity is uniform across the film and viscous dissipation is negligible.

Flow Rate of a Contact Liquid on a Liquid-Impregnated Surface

The flow rate of contact liquid on a liquid-impregnated surface depends on the viscosity of the viscosity of the contact liquid, the viscosity of the impregnating liquid, the height of the solid features, the depth of the contact liquid (e.g., the height of the contact liquid above the liquid-impregnated surface). This can be understood by studying the flow of a contact liquid through a pipe or channel that includes a liquid-impregnated surface. Typically, flow through a pipe or channel, having a liquid-impregnated surface on its interior can be described by the following equation:

Q/(Δp/L)˜(R⁴/μ₁)(1+C(h/R)(μ₁/μ₂) (16)

where Q is the volumetric flow rate, R is pipe radius, h is the height of the texture, μ₂ is the viscosity of the impregnating liquid, and μ₁ is the viscosity of the contact liquid flowing through the pipe. C is a constant that relates to the obstruction of the flow of the impregnating liquid due to the texture. C=1 in the limit of infinitely sparse textures (no texture) approaches 0 for very tightly spaced textures. Δp/L is the pressure drop per L. Note that C*h*(μ₁/μ₂) defines a slip length, b. Without being bound to any particular theory, it is believed that (h/R)(μ₁/μ₂) is greater than 1 for this to have a significant effect and this sets the height of the texture in relation to the viscosity ratio.
Power˜(Δp/L)*Q (here “˜” means “scales as”)
So equation (16) becomes:

$$\frac{{Q}^{2}}{Power} ∼ ( \frac{{R}^{4}}{{μ}_{1}} ) [ 1 + C ( \frac{t}{R} ) ( \frac{{μ}_{1}}{{μ}_{2}} ) ] \qquad ( 17 )$$

Then the ratio of the flow rate of a liquid without the coating to one with the coating, at the same pumping power, is:

$$\frac{{Q}_{coated}}{{Q}_{uncoated}} ∼ {[ 1 + C ( \frac{h}{R} ) ( \frac{{μ}_{1}}{{μ}_{2}} ) ]}^{\frac{1}{2}} \qquad ( 18 )$$

Or the reduction in power require to achieve the same flow rate is:

$$\frac{{P}_{coated}}{{P}_{uncoated}} ∼ {[ 1 + C ( \frac{h}{R} ) ( \frac{{μ}_{1}}{{μ}_{2}} ) ]}^{- 1} \qquad ( 19 )$$

If h<<R, then the flow of the product also drags the material within the film at a flow rate Q_{f} given by:

Q_{f}/Q=h/R[2b/R+(b/R)²]/[1/2+2b/R+(b/R)²] (20)

If b/R<<1 then:

Q_{f}/Q˜4hb/R² (valid for h<R and b/R) (21)

Although modeled for pipe flow, the general principals also apply to open systems, for example, product containers, where R is replaced with the characteristic depth of the flowing material. The average velocity of the flow ˜Q/A, where A is the cross-sectional area of the flowing fluid.

For example, mayonnaise, which is a Bingham plastic, has a viscosity that approaches infinity at low shear rates (it is non-Newtonian), and therefore behaves like a solid as long as shear stress within it remains below a critical value. Whereas, for honey, which is Newtonian, the flow is much slower. For both systems, h and R are of the same order of magnitude, and μ₂ is the same. However, since

μ_{honey}<<μ_{mayonnaise}, then (h/R)(μ_{honey}/μ₂)<<(h/R)(μ_{mayonnaise}/μ₂)

thus mayonnaise flows much more quickly out of the bottle than honey. Therefore, to increase the flow rate of honey, an impregnating liquid can be selected that has a lower viscosity μ₂ such that the ratio μ_{honey}/μ₂ increases, and thereby the flow rate of the contact liquid over the liquid-impregnated surface increases. In some embodiments, μ₁/μ₂ can be greater than about 1, about 10, about 10³, about 10⁶, about 10⁹.

### Inhibiting Nucleation of Dissolved Gases

Liquid-impregnated surfaces have an outer surface of mostly liquid, which significantly inhibits nucleation of vapor or gas dissolved in a liquid. Similarly, liquid-impregnated surfaces can also be used to inhibit boiling by reducing nucleation sites. Similarly, liquid-impregnated surfaces can also be used to inhibit cavitation by preventing the formation of bubbles.

In some embodiments, a vessel, for example a soda can or a beer glass can include a liquid-impregnated surface. The liquid-impregnated surface is formed on a first surface, for example, an interior surface of the vessel by disposing a plurality of solid features on it, for example, using spray coating or any other method described herein. The first surface can have a first roll off angle towards a contact liquid. The plurality of solid features are configured to define interstitial regions between the solid features. An impregnating liquid is disposed in the interstitial regions and on the solid features to form a substantially continuous layer and furthermore, the impregnating liquid adheres to the solid features and the interstitial regions. The interstitial regions are dimensioned and configured to remain impregnated by the impregnating liquid. The impregnating surface can at least partially define a second surface having a second roll off angle less than the first roll off angle. The second surface defined by the liquid-impregnated surface of the vessel is configured so that the vessel has less nucleation sites for the formation of gas and vapor bubbles when compared with a similar vessel that does not include a liquid-impregnated surface thereon. In some embodiments, the impregnating liquid can be immiscible with the liquid disposed in the vessel. The impregnating liquid can be non toxic, for example, formulated from edible materials. In some embodiments, a low energy coating, for example, OTS or any other low energy coating (e.g., hydrophobic coatings such as silanes) can be disposed between the plurality of solid features and the impregnating liquid, for example, to promote adhesion. The liquid disposed in the vessel can be any liquid which has a dissolved gas included in it, for example, a carbonated or a nitrogenated liquid, such as, for example, a beverage, beer, soft drink, or any other liquid with a gas dissolved in it.

In some embodiments, a vessel for heating a liquid and having a liquid-impregnated surface includes an interior surface. The vessel can be any heating vessel, for example, cookware, tank, or any other heating vessel. The vessel can be made from any suitable material including but not limited to metal, plastic, ceramic, or any other material. A plurality of solid features are disposed on a first surface, for example, an interior surface of the vessel, having first roll off angle such that the plurality of solid features define interstitial regions between them. An impregnating liquid, for example, any of the impregnating liquids described herein, is disposed in the interstitial regions and on the solid features, such that the impregnating liquid forms a substantially continuous layer and furthermore, adheres to the solid features and the interstitial regions. The interstitial regions are dimensioned and configured to remain impregnated by the impregnating liquid. The impregnating surface can at least partially define a second surface having a second roll off angle less than the first roll off angle. The second surface of the liquid-impregnated surface can have substantially less nucleation sites for formation of bubbles in a contact liquid that is disposed on the second surface and is heated to release a gas (e.g., air) dissolved in the contact liquid, as compared to the first surface. The impregnating liquid is formulated to be immiscible with a fluid disposed in the internal volume defined by the container, for example, a liquid to be heated by the container. The liquid-impregnated surface of the vessels is configured to have less nucleation sites for the formation of gas and vapor bubbles compared to a similar vessel that does not include the liquid-impregnated surface. For example, liquid water normally boils at 100° C. at atmospheric pressure. Water in a vessel with liquid-impregnates interior surfaces can be superheated above 100° C. due to a lack of nucleation sites to initiate the boiling process.

In some embodiments, active surface of impellers and propellers include a liquid-impregnated surface. As the propeller rotates within the liquid and creates regions of high and low pressure, the liquid-impregnated surface inhibit the formation of cavitation bubbles. For example, the propeller or impeller includes a hub with at least one blade disposed on it. The blade has parts including the leading edge, trailing edge, face, back, and fillet. Each part includes a first surface having a first roll off angle. A liquid-impregnated surface can be disposed on the first surface, for example, by forming solid features on at least one or more parts of the blade such that the solid features define interstitial regions within which an impregnating liquid is disposed. The interstitial regions can be dimensioned and configured to remain impregnated by the impregnating liquid. The impregnating liquid can at least partially define a second surface having a second roll off angle less than the first roll off angle. Furthermore, the second surface can have substantially less cavitation in a contact liquid in contact with the second surface, as compared to the first surface. The roll off angle of the liquid-impregnated surface can be the same or can differ on separate parts of the blade. For example, the roll off angle of liquid-impregnated surface on the leading edge and face can be less than the roll off angle of liquid-impregnated surface on the trailing edge and back. This can, for example, prevent cavitation from occurring on those parts of the blade. In some embodiments, only some parts of the blade of the propeller can be preferentially configured to define the liquid-impregnated surface, for example, to restrict cavitation to only the parts without the liquid-impregnated surface. This can, for example, be used to create turbulence only at certain parts, for example, to aid propulsion.

The following examples show performance of various liquid-impregnated surfaces towards inhibition condensation, performance of various liquid impregnated surfaces towards various contact liquids, and inhibition of nucleation of beverages in contact with the liquid-impregnated surfaces. These examples are for illustrative purposes only and are not intended to limit the scope of this disclosure.

### Example 1

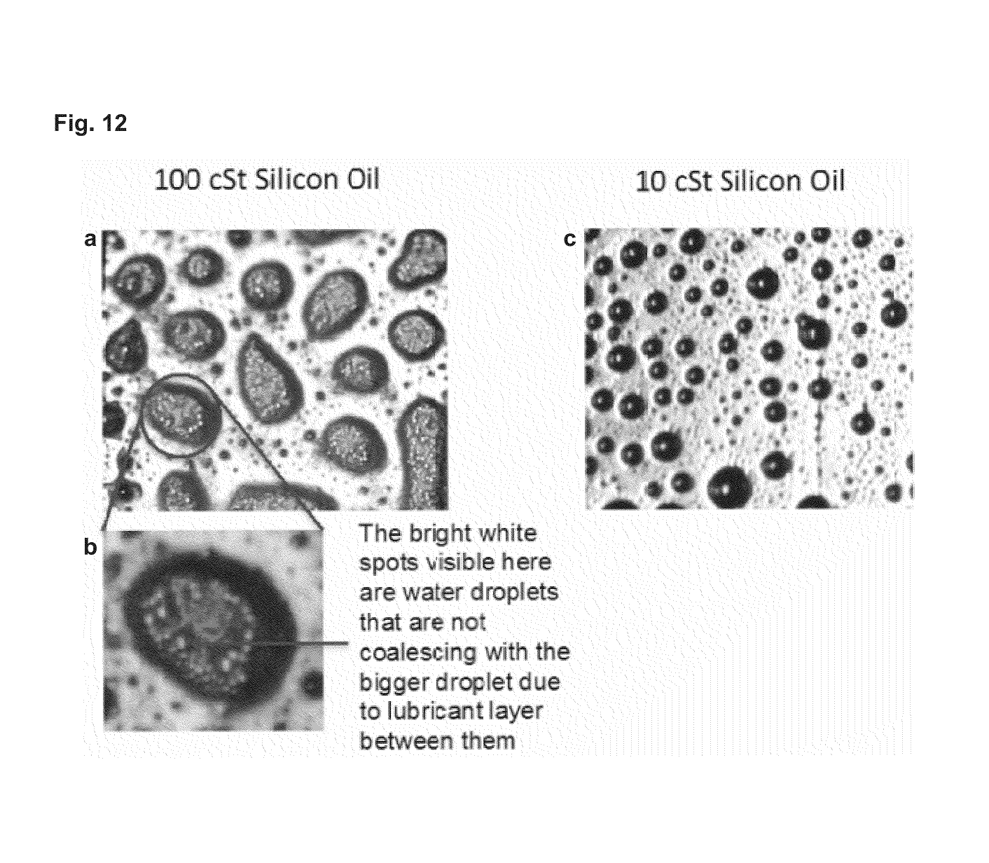

FIG. 12a shows a first liquid-impregnated surface that includes a 100 cSt silicone oil as the impregnating liquid. FIG. 18c shows a second liquid-impregnated surface that includes a 10 cSt silicone oil. Both liquid-impregnated surfaces were cooled to a temperature of about −5 degrees Celsius using a Peltier cooler while being disposed in a room set a temperature of about −20 degrees Celsius. This very high cooling was sufficient to overcome the cloaking phenomenon of the 10 cSt silicon oil included in the second liquid-impregnated surface of FIG. 18c. Water droplets condensing on the second liquid-impregnated surface had hemispherical shapes. In contrast, the barrier for coalescence of the higher viscosity 100 cSt oil included in the first liquid-impregnated surface was much higher even at this high degree of sub-cooling. As shown in the enlarged view of a portion of the first liquid-impregnated surface shown in FIG. 18b, the sphericity of the water droplets on the first liquid-impregnated surface is substantially lower relative to the sphericity observed on the second liquid-impregnated surface. Furthermore, the coalescing of the droplets is substantially reduced.

### Example 2

This example demonstrates results of a series of experiments that included flowing a number of different external phases on a number of different solid surfaces impregnated with different impregnating liquids. The results of the conducted experiments are shown in Table 3 below. In Table 3 below, θ_{os(a),receding} is the receding contact angle of the impregnating liquid (e.g., silicone oil, subscript ‘o’) on the surface (subscript ‘s’) in the presence of air (subscript ‘a’), and where θ_{os(e),receding} is the receding contact angle of the impregnating liquid (e.g., silicone oil, subscript ‘o’) on the surface (subscript ‘s’) in the presence of the external phase (subscript ‘e’), θ*_{c}=Cos⁻¹ (1/r) is the critical contact angle on the textured substrate and α* is the roll-off angle.

TABLE 3
Experimental determination of roll-off angles.

| | | | | | | θ_{os(α),} _{receding}, | |
|---|---|---|---|---|---|---|---|
| External | | Impregnating | Θₒₛ₍ₐ₎, _{receding} | θ_{os(e), receding} | Cos⁻¹(1/r) = θ_{c}* | θ_{os(e), receding} < | α* |
| phase (e) | Solid (s) | liquid (o) | (°) | (°) | (°) | θ*_{c} | (°) |
| Mayonnaise | CW | PDC | 0 | 37 | 47 | Yes | 5 |
| Toothpaste | CW | PDC | 0 | 25 | 47 | Yes | 3 |
| Toothpaste | WPTFE | PDC | 20 | 67 | 50 | No | 45 |
| WB Paint | WPTFE | PDC | 20 | 67 | 50 | No | 65 |
| WB Paint | WPTFE | Krytox 1506 | 2 | 35 | 50 | Yes | 15 |
| Peanut | WPTFE | PDC | 20 | 90 | 50 | No | 70 |
| Butter | | | | | | | |
| Peanut | WPTFE | CL | 5 | 35 | 50 | Yes | 20 |
| Butter | | | | | | | |
| DI Water | OTS- | Silicone oil | 0 | 0 | 60 | Yes | ~1 |
| | treated | | | | | | |
| | silicon | | | | | | |
| DI Water | Silicon | Silicone oil | 0 | 122 | 60 | No | Did |
| | | | | | | | not |
| | | | | | | | roll |
| | | | | | | | off, |
| | | | | | | | even |
| | | | | | | | at 90° |

Slide off angles were measured using 500 μL volumes of the external fluid, except for water, for which 5 μL droplets were used. It was observed that in experiments where θ_{os(e),rec}<θ_{c}*, the roll-off angles, α*, were low (e.g., less than or equal to 20°), whereas in cases where θ_{rec,os(e)}>θ_{c}*, the roll-off angles, α*, were high (e.g., greater than or equal to 40°).

The silicon surfaces used in the experimental data shown in Table 3 above were 10 lam square silicon posts (10×10×10 μm) with 10 μm interpillar spacing. The 10 μm square silicon microposts were patterned using photolithographic and etched using deep reactive ion etching (DRIE). The textured substrates were cleaned using piranha solution and were coated with octadecyltrichlorosilane (OTS from Sigma-Aldrich) using a solution deposition method.

The “WPTFE” surfaces shown in Table 3 above were composed of a 7:1 spray-coated mixture of a mixture of Teflon particles and Toko LF Dibloc Wax, sprayed onto a PET substrate. The carnauba wax (CW) surfaces were composed of PPE CW spray-coated onto a PET substrate. The impregnating liquids were propylene di(caprylate/caprate) (“PDC”), Krytox 1506, DOW PMX 200 silicone, oil, 10 cSt (“Silicone oil”) and Christo-lube EXP 101413-1 (“CL”). The external phases used were mayonnaise, toothpaste (e.g., Crest extra whitening), and red water based paint. Wenzel roughness, r, was measured using a Taylor hobson inferometer. Although precise estimates of φ could not be easily obtained, it was observed in the inferometer that φ was much less than 0.25 for all the impregnated surfaces described in the table, and tested, and using 0.25 as an upper bound on φ for our surfaces we determine that cos⁻¹ ((1−φ)/(r−φ))=θ_{c}, is no more than 5° greater than the values for θ*_{c}.

### Example 3

A liquid-impregnated surface was prepared similar to the preparation method for the embodiment 200 show in FIG. 2-5. Briefly, a silicon surface was lithographically patterned and etched to form solid posts having a height of 10 μm and a width of 10 μm, having inter-feature spacing of 10 μm which defines the interstitial regions for receiving the impregnating liquid. The surface was then treated with OTS and then slowly dipped in 10 cSt silicon oil as the impregnating liquid.

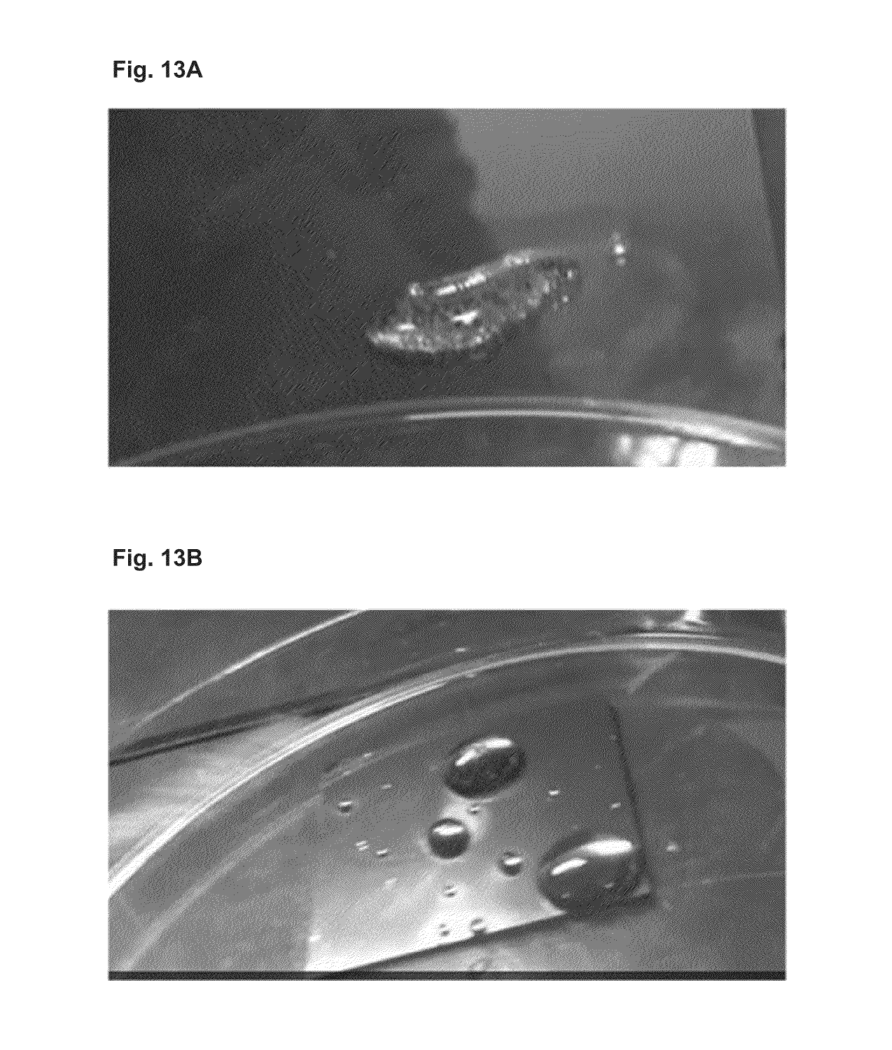

Referring now to FIGS. 13A and 13B, a drop of diet coke was disposed on a plain glass surface as shown in FIG. 13A. Gas Nucleation sites were immediately formed as visible by the gas bubbles in the diet coke droplet as shown in FIG. 13A.

A few drops of the diet coke were now disposed on the liquid-impregnated surface described herein, as shown in FIG. 13B. No gas bubbles are visible, clearly showing that the liquid-impregnated surface inhibits the gas nucleation sites in the diet coke droplet.

### Example 4

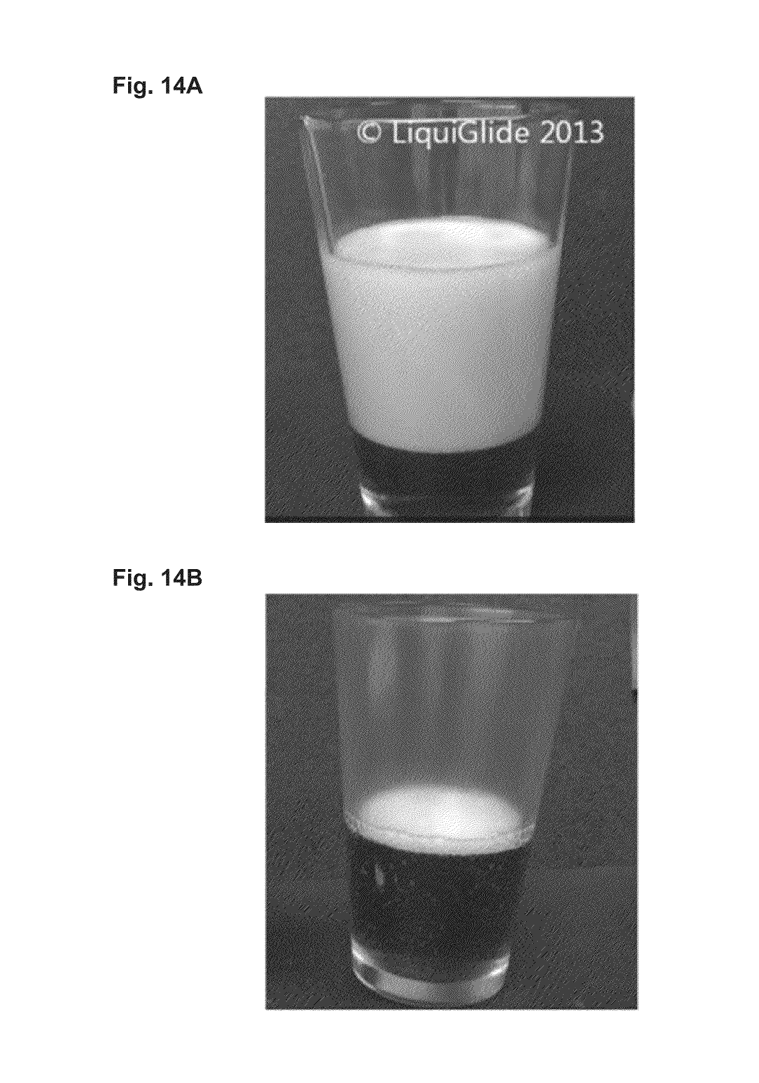

A commercially available beer glass was configured to define a liquid-impregnated surface, by spray coating. The nucleation characteristics of the liquid-impregnated glass was compared with an untreated glass with a commercially available beer disposed in each of the glass. FIG. 14A shows the untreated glass with the beer disposed in the internal volume defined by the beer glass. Fizzing is clearly visible. In contrast, FIG. 14B shows a substantially similar beer glass that was configured to define a liquid-impregnated surface on the interior surface of the beer glass which will be contact with the beer, for example, using any of the methods described herein. As shown, very little fizzing is visible and only a few nucleation sites can be seen clearly indicating that the liquid-impregnated surface is effectively minimizing nucleation.

While various embodiments of the system, methods and devices have been described above, it should be understood that they have been presented by way of example only, and not limitation. Where methods and steps described above indicate certain events occurring in certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An apparatus having a liquid-impregnated surface, comprising:
A first surface having a first roll off angle;
a plurality of solid features disposed on the first surface, the plurality of solid features defining interstitial regions between the plurality of solid features;
an impregnating liquid disposed in the interstitial regions, the interstitial regions dimensioned and configured to remain impregnated by the impregnating liquid through capillarity; and
a second surface having a second roll off angle less than the first roll off angle defined at least in part by the impregnating liquid disposed in the interstitial regions;
wherein the second surface has substantially less nucleation sites for formation of bubbles in a contact liquid that includes a gas dissolved therein and is disposed on the second surface, as compared to the first surface.

2. The apparatus of claim 1, wherein the impregnating liquid is immiscible with the contact liquid.

3. The apparatus of claim 1, wherein the impregnating liquid is non toxic.

4. The apparatus of claim 1, wherein the impregnating liquid is edible.

5. The apparatus of claim 1, further comprising a low energy coating disposed between the plurality of solid features and the impregnating liquid.

6. The apparatus of claim 5, wherein the impregnating liquid preferentially adheres to the low energy coating rather than the solid features.

7. The apparatus of claim 1, wherein the contact liquid is carbonated.

8. The apparatus of claim 1, wherein the contact liquid is nitrogenated.

9. The apparatus of claim 7, wherein the contact liquid is a soft drink.

10. The apparatus of claim 8, wherein the contact liquid is beer.

11. The apparatus of claim 1, wherein the contact liquid is a beverage.

12. A vessel for heating a liquid having a liquid-impregnated surface, comprising:
an first surface having a first roll off angle;
a plurality of solid features disposed on the first surface, the plurality of solid features defining interstitial regions between the plurality of solid features; and
an impregnating liquid disposed in the interstitial regions, the interstitial regions dimensioned and configured to remain impregnated by the impregnating liquid through capillarity; and
a second surface having a second roll off angle less than the first roll of angle defined at least in part by the impregnating liquid disposed in the interstitial regions
wherein the second surface has substantially less nucleation sites for formation of bubbles in a contact liquid that is disposed on the second surface and is heated to release a gas dissolved in the contact liquid, as compared to the first surface.

13. The vessel of claim 12, wherein the vessel is cookware.

14. The vessel of claim 12, wherein the vessel is a tank.

15. The vessel of claim 12, wherein the vessel is a made of a metal.

16. The vessel of claim 12, wherein the vessel is a made of a plastic.

17. The vessel of claim 12, wherein the vessel is a made of a ceramic.

18. The vessel of claim 12, wherein the impregnating liquid is immiscible with the contact liquid.

19. An apparatus having a liquid-impregnated surface, comprising:
a hub rotatable about a central axis;
at least one blade connected to the hub having parts comprising a leading edge, a trailing edge, a fillet, a face, and a back, each part including a first surface having a first roll off angle;
a plurality of solid features disposed on the first surface of at least one part of the blade, the plurality of solid features defining interstitial regions between the plurality of solid features;
an impregnating liquid disposed in the interstitial regions, the interstitial regions dimensioned and configured to remain impregnated by the impregnating liquid through capillarity;
a second surface of the at least one part of the blade, the second surface having a second roll off angle less than the first roll off angle, and defined at least in part by the impregnating liquid disposed in the interstitial regions;
wherein the second surface has substantially less cavitation in a contact liquid in contact with the second surface, as compared to the first surface.

20. The apparatus of claim 19, wherein the apparatus is at least one of a propeller or an impeller.
